(19) United States
(12) Patent Application Publication
(10) Pub. No.: US 2025/0190748 A1
(43) Pub. Date: Jun. 12, 2025

(54) EVOLUTIONARY COMPUTATIONAL MODULAR NEURAL NETWORKS, STRUCTURES AND METHODS, INCORPORATING EVOLUTIONARY COMPUTATIONAL ECONOMIC DATA SYSTEMS, AND ADAPTIVE, EMERGENT, EVOLUTIONARY AUGMENTED ECONOMIC DATA SYSTEM MACHINE LEARNING

(71) Applicant: Patrick Joseph Byrne, Galson (AU)

(72) Inventor: Patrick Joseph Byrne, Galson (AU)

(21) Appl. No.: 18/841,373

(22) PCT Filed: Feb. 27, 2023
(86) PCT No.: PCT/IB2023/000118

§ 371 Date: Oct. 26, 2023

Related U.S. Application Data
(60) Provisional application No. 63/315,248, filed on Mar. 1, 2022.

(30) Foreign Application Priority Data
Feb. 27, 2023 (WO) PCT/IB2023/000118

(51) Int. Cl. G06N 3/04

(52) U.S. Cl. CPC G06N 3/04

(57) ABSTRACT

Disclosed herein are evolutionary computational modular neural networks, structures and methods: incorporating evolutionary computational economic data system structures and methods; and adaptive, emergent, evolutionary economic data system machine learning structure and methods: that create, govern, constrain and contextualize, the stochastic selections and configurations, of adaptive, emergent and evolving goods, services and assets, contextual data, structures, dimensions, connections, relationships, perspectives, parameters and exchange mechanisms, including location and utility, between and among self-organizing supply and demand agent computing devices.

### FIELD OF INVENTION

This disclosure is related to technical improvements in the structure, methods and performance of modular neural networks, incorporating evolutionary computational economic data system structures and methods; and more particularly, computational adaptive, emergent and evolutionary, augmented economic data system machine learning structures and methods.

### NOTICE OF COPYRIGHT

A portion of this disclosure contains material that is subject to copyright protection. The copyright owner has no objection to the facsimile reproduction by anyone of the material subject to copyright protection as it appears in the United States Patent & Trademark Office's patent file or records, but otherwise reserves all copyright rights whatsoever.

### BACKGROUND

The internet has changed supply and demand trading data networks. Traditional enterprise computer network architectures for trading inter-networking goods, services and assets data can be rife with weak data links, missing data links and data bottlenecks.

Many supply and/or demand agent computing devices have to contend with increasing global data connectedness, supply and demand data network interdependencies, complexity, competition, pandemics and climate change, and the mobilization of data technology systems, at accelerating inter-network communication speeds; while being limited in their ability to create effective network level (end-to-end) supply and demand network alignment and collaboration.

Consequently many supply and/or demand agent computing devices may have difficulty in sensing demand supply market data signals early enough, making it difficult for supply and/or demand agent computing devices to manage product innovation, data, structures, capabilities, capacities and service levels flexibly enough; and therefore be unable to respond to marketplace data, structure and contextual changes quickly enough.

The digital marketplace complexity, rapid data changes, coupled with the limitations of current IT architectures and their associated deployment paradigms can make it an almost impossible task for existing individual and collective self-organizing supply and/or demand agent computing devices data structures, to select, configure, exchange, store, verify, map, track and trace the evolving context, timing, conditions, provenance, fulfillment, and proof of dynamic supply and/or demand trade data exchange mechanisms, that occur throughout goods and/or services and/or assets data industry networks, from data genesis to consumption.

### PRIOR ART

Conventional supply and demand data networks may be linear and enterprise centric, where the exchange of goods, services and assets data with other enterprises may be executed through middleware data and/or middleman data and/or blockchain miner data intermediaries. Enterprise centric system architectures can result in a patchwork of predefined features, functions, rules, and disparate data sets; that may comprise complicated and diverse siloed data architectures; which are instantiated, administered and executed on proprietary computing data systems, of different scales and technologies, coded on different supply and demand agent computing devices, in different computing languages, implemented at different times and for different purposes.

The disparate siloed data sets may be attached to message-oriented middleware (MOM) data and/or middleman brokered data and/or blockchain miner intermediary data structures that support the sending, parsing and receiving of predefined features, functions, rules and data sets, may require each participating enterprise to constantly reestablish trade data context between and among the distributed enterprise centric computational trading data enterprises.

The economic data, structures, context, location and utility may be required to be reestablished for each trade, or parts thereof. The reestablishment of context may be necessary, because the feature, function, rules, and data structures that create, govern, constrain and contextualize many current enterprise centric supply and demand data network enabled solutions may be discontinuous, or largely fixed or lack adequate data granularity. They may not vary with dynamic and uncertain non-linear trading network features, functions, rules, relationships and evolving data structure contexts.

The functional rigidity of the siloed enterprises computer system architectures can limit their ability to adapt to changes in dynamic non-linear trading data, structures, dimensions, connections, relationships, perspectives, parameters, exchange mechanisms, including context, location and utility environments.

### LIST OF FIGURES

FIG. 1: Shows dynamic network Architecture elements, selection, curation and configuration (Overview) encompassing an example of the common curated dynamic network architecture elements required for the selection and configuration of evolutionary computational modular neural networks, evolutionary computational economic data system(s), and evolutionary computational economic data system machine learning, and how said architecture elements and configuration may be categorized and applied, by curation, among other examples.

FIG. 2: Shows alternating base-paired data configuration protocols enabled by the dynamic network architecture elements (data) encompassing an example of the plurality of alternating base paired data configuration protocols that may be utilized by agent computing devices to drive the combinations, sequences, mutation and recombination of the dynamic network architecture elements, data, structures, dimensions, connections, relationships, exchange mechanisms, including context, location and utility to form adaptive, emergent and evolutionary, economic data blocks, among other examples.

FIG. 3: Shows economic data blocks-curation, dynamic network architecture configuration inputs to augmented economic data system machine learning and evolutionary computational modular neural networks encompassing an example of the curation, selection and configuration data inputs to augmented economic data system machine learning and evolutionary computational modular neural networks; to create, govern, constrain and contextualize data within evolutionary computational economic data system(s), among other examples.

FIG. 4: Shows an evolutionary computational economic data system-dynamic network architecture, layers, engines, and structure(s) encompassing an example of a unified economic data system utilizing evolutionary computational modular neural network(s) and augmented economic data system machine learning, supporting demand/or supply computing agent device selections, activities, data, structure, dimensions, connections, relationships, exchange mechanisms, including context, location and utility, among other examples.

FIG. 5: Shows evolutionary computational economic data system(s) curation and configuration encompassing an example of the processes through which an adaptive, emergent, evolutionary computational economic data system(s) may be selected and configured by a curation agent computing device, among other examples.

FIG. 6: Shows evolutionary computational economic data System(s)—demand/or supply agent computing apparatus presented as a high level overview example of one possible embodiment of a supporting computing system apparatus and related devices, among other examples.

FIG. 7: Shows agent computing device registration—initiating—private trading network(s) within the economic data system encompassing an example of the high level processes for registration of supply and/or demand agent computing devices, and implementation of a plurality of meshed private trading data network(s) within an economic data system(s), among other examples.

FIG. 8: Shows agent computing device registration encompassing an example of the low level process detail of stochastic selections and configurations that a supply and/or demand agent device(s) may utilize to activate roles and initiate private trading networks, among other examples.

FIG. 9: Shows private trading network(s)—network initiation—within a defined industry within a selected market (shown for one market) encompassing an example of a low level representation showing a private trading network initiated by a single demand/or supply agent computing device, among other examples.

FIG. 10: Shows private trading network(s)—creation and evolution—acceptance or rejection of a relationship—within a defined industry, within a selected market, within a selected taxonomy, encompassing an example of dynamic relationship establishment where each demand/or supply agent computing device's network represents one sub-set of the plurality of possible relationships, at a given point in time, among other examples.

FIG. 11: Shows self-organization—showing a plurality of demand/or supply agent(s) private trading networks establishing a wirearchy—mesh network—with a sample of 5 marketplaces being shown as an example of the concept of concatenated private trading networks described in FIG. 10 showing multi-marketplace(s), data, structures and scale for a plurality of supply and/or demand agent computing devices, representing a sub-set of the plurality of possible relationships, within an evolutionary computational economic data system, among other examples.

FIG. 12: Shows catalog development and deployment encompassing an example of a high level description of the process of publish and subscribe, for a supply and/or demand agent computing device, among other examples.

FIG. 13: Shows dynamic mask catalogue(s), creation, and evolution encompassing an example of a low level process description with a selection of possible interactions and outcomes for one embodiment of the publishing of a plurality of capabilities, general, private and customized catalogs supporting a plurality of catalog data structures and context, with mask views, for a supply and/or demand agent computing device(s), among other examples.

FIG. 14: Shows agent computing devices—catalog(s) showing Customized Views applied—with selective acceptance and discounts applied encompassing an example of a low level description of one embodiment of the application of customization, utilizing mask views on the supply side, for an individual supply agent computing device, with a condensed and customizable view(s) of that data, structures, dimensions, connections, relationships, exchange mechanisms, including context, location and utility, for a plurality of demand agent computing device relationships and a plurality of individual catalogs to produce customized views, supporting related bi-directional transactional data translation and transaction processing capability, among other examples.

FIG. 15: Shows private trading networks—catalog views with supply agent plurality encompassing an example of a low level description of one embodiment of the application of customization of mask views by a demand agent computing device data, structures, dimensions, connections, relationships, exchange mechanisms, including context, location and utility, that connects to a plurality of supply agent computing devices, and condenses and customizes that data from a plurality of established supply agent computing device relationships and a plurality of catalogs, to create a singular view, and a related data translation during transaction processing, among other examples.

FIG. 16: Shows dynamic inventory allocation and augmented economic data system machine learning-inventory allocation, prediction and actual demand encompassing an example of a low level description of one embodiment of augmented economic data system machine learning applied to dynamic inventory allocation by an individual supply agent computing device, supporting a goods, and/or services and/or assets transaction's capability, capacity and service level(s) with a plurality of demand agent computing devices, among other examples.

FIG. 17: Shows catalog plurality-selective acceptances condensed to a supply/demand agent computing device view, with the application of taxonomy to the classification of catalog data sets for one marketplace and related transactional meta-data encompassing a low level description of one embodiment of the types of contextual data, structures, dimensions, connections, relationships, exchange mechanisms, including context, location and utility, and data granularity, available on, and captured by, the economic data system, among other examples.

FIG. 18: Shows application of augmented economic data system machine learning and evolutionary computational modular neural networks to prediction accuracy encompassing an example of a high level overview of the application of augmented economic system machine learning, and evolutionary computational modular neural networks, to the analysis of data, structures, dimensions, connections, relationships, exchange mechanisms, including context, location and utility, with the outputs stored within the economic data system, providing insight and feedback to supply and/or demand agent computing devices, data, structures, dimensions, connections, relationships, exchange mechanisms, including context, location and utility, and by inference provide an analogue of the selected marketplace(s), data, structure, factors and the behavior (trends) of the wider marketplace(s) and/or industry, and by inference the marketplace(s) of registered supply and/or demand agent computing devices and non-registered demand/or supply agent computing devices, among other examples.

FIG. 19: Shows application of augmented economic data system machine learning/evolutionary computational modular neural networks to demand/or supply management, inventory management, and inventory optimization encompasses an example of a high level overview of the application of augmented economic data systems machine learning, and evolutionary computational modular neural networks, applied to supply and demand predictions and dynamic goods, and/or services, and/or assets allocation of individual and/or collective registered supply and/or demand agent computing devices, among other examples.

FIG. 20: Shows transactions and data-high level (the components-consolidated and deconsolidated orders example) encompassing an example of a high level description of transaction processes and related data, structures, dimensions, connections, relationships, exchange mechanisms, including context, location and utility, data granularity as an input to augmented economic data system machine learning, among other examples.

FIG. 21: Shows a computer knowledge base dataset-contextual data-supervised, unsupervised and Reinforcement Learning Deployment with an example of a general overview of an embodiment encompassing the use of computer knowledge base datasets, and the application and utilization of augmented economic data system machine learning applied to the capture, analysis and interpretation of economic data, structures, dimensions, connections, relationships, exchange mechanisms, including context, location and utility, encompassing the selections, parameters and service levels data captured and stored within the evolutionary computational economic data system, among other examples.

In all the Fig(s), the arrows, the arrowhead directions, and the lines indicating connections among various objects within, and between individual figures, represents a logical relationship in data.

### DESCRIPTION

The subject matter of the technology described herein is described with specificity to meet statutory requirements. However, the description itself is not intended to limit the scope of this patent. Rather, the inventor has contemplated that the claimed subject matter might also be embodied in other ways, to include different steps and/or combinations, sequences, mutations and recombinations of steps similar to the ones described in this document, in conjunction with other present or future technologies.

Moreover, although the terms “dynamic network architecture” “base paired data definition protocols” and/or “combinations” and/or “sequences” and/or “mutations” and/or “re-combinations”may be used herein to connote different elements, structures and methods employed, the terms should not be interpreted as implying any particular order among or between various steps herein disclosed unless and except when the order of individual steps is explicitly described.

The invention relates to improved structures, methods and performance of at least one evolutionary computational modular neural network(s); instantiated in at least one computational shared database, on at least one shared computing apparatus, selectively shared between and among supply and demand agent computing devices, over a computer network; comprising a common dynamic network architecture; that incorporates curated invariant, interrelated, interconnected, interoperable, interactive, inter-networking elements; wherein each individual and/or collective element(s) serve as a module(s); that combine, sequence, mutate and recombine, through the selective applications of alternating base paired data configuration protocols, over time and space, creating economic data blocks; that are activated by a plurality of stochastic selections and configurations, data, structures, dimensions, connections, relationships, perspectives, parameters, exchange mechanisms, including context, location and utility, that are stored and shared selectively between and among a plurality of self-organizing agent computing devices.

The dynamic network architecture elements, driven by the alternating base paired data configuration protocols and activated by the self-organizing agent computing devices selections and configurations data; create, govern and constrain the economic data system, data, dimensions, connections, relationships, perspectives, parameters, exchange mechanisms, including context, location and utility of evolutionary computational economic data system(s) and augmented evolutionary computational economic data system(s) machine learning.

Thus providing technical improvements in the structure, methods and performance of modular neural networks, evolutionary computational economic data systems structure, methods and performance; and more particularly, to computational adaptive, emergent and evolutionary, augmented economic data system machine learning structure, methods and performance by:
Increasing the speed, scale, scope and flexibility of computer and/or software economic data processing throughput, in evolutionary computational modular neural networks
Requiring less programming, by curation and supply and demand agent computing devices
Eliminating the need for message-oriented middleware (MObrokered and/or Blockchain miner intermediary data systems
Providing context to all aspects of evolutionary computational modular neural networks by utilizing dynamic network architecture elements, alternating base paired data configuration protocols and self-organizing supply and demand agent computing device data inputs and outputs
Processing and executing economic data system transactions, while retaining the economic data, dimensions, connections, relationships, perspectives, parameters, exchange mechanisms, including context, location and utility, utilizing codeless user interfaces, and less data
Eliminating the need for big data cleansing of the inputs to modular neural networks and economic data system machine learning to process and analyze the activities and the adaptive, emergent and evolutionary data inputs/outputs of the economic data system
Utilizing less computing apparatus and requiring less energy and maintenance

### EMBODIMENTS

In the following embodiments, the diagram descriptions below are set out as examples of the evolutionary computational modular neural networks, structures and methods; evolutionary economic data system utility, and adaptive, emergent, evolutionary economic data system machine learning; in which the adaptive, emergent, and evolving economic data blocks data, structures, dimensions, connections, relationships, perspectives, parameters and exchange mechanisms, including context, location and utility; are made and used to scale and provide data genesis to ultimate consumption transaction processing, within the adaptive, emergent and evolving economic data blocks, private trading data networks, economic data system, and economic data system machine learning, among other examples.

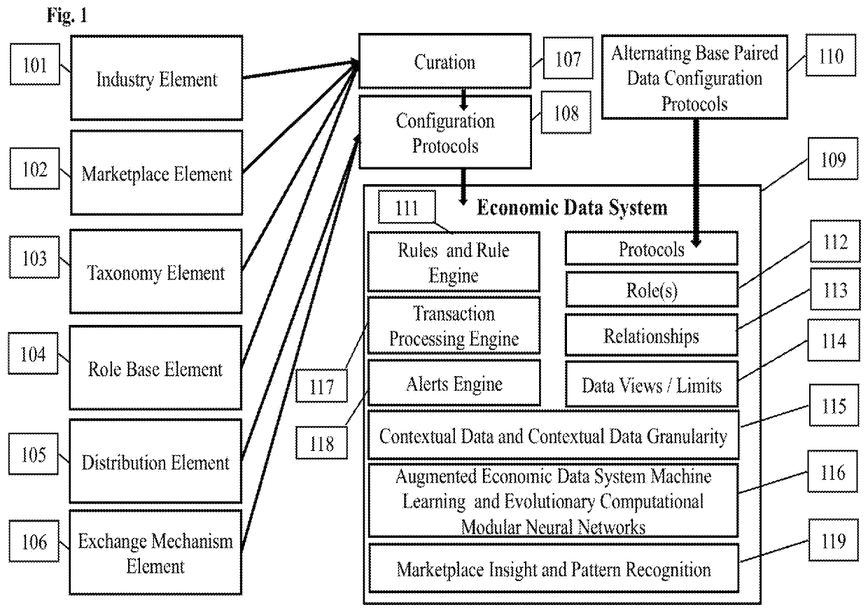

1. In this embodiment, FIGS. 1 101, 102, 103, 104, 105, and 106 shows a plurality of adaptive, emergent and evolving dynamic network architecture elements that interrelate, interconnect, interoperate, interact and inter-network. The common, curated, dynamic networks architecture elements combine, sequence, mutate and recombine, to create, govern, constrain and contextualize a plurality of self-organizing supply and/or demand agent computing devices, dynamic data structures and the self-selectable, adaptive, emergent and evolutionary goods and/or services and/or assets configurations data they activate, configure and exchange; create and store said elements and data within the evolutionary economic data system as shown in FIG. 1 109; including the sub-components shown in FIGS. 1 111, 112, 113, 114, 115, 116, 117, 118, and 119; encompassing their data, structures, dimensions, connections, relationships, exchange mechanisms, including context, utility, and data granularity, among other examples.

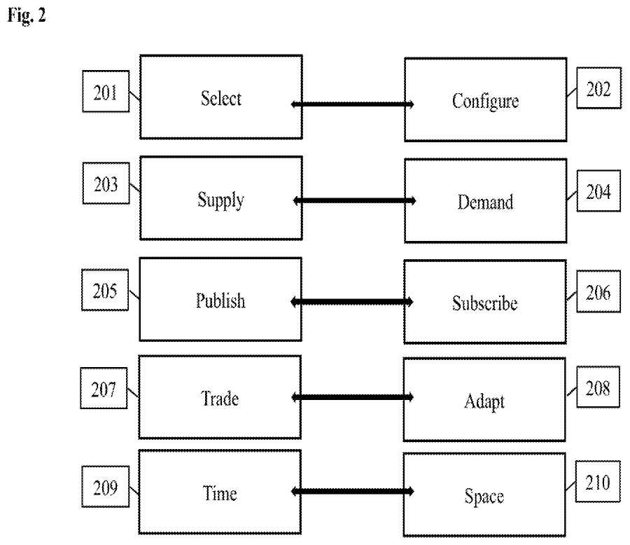

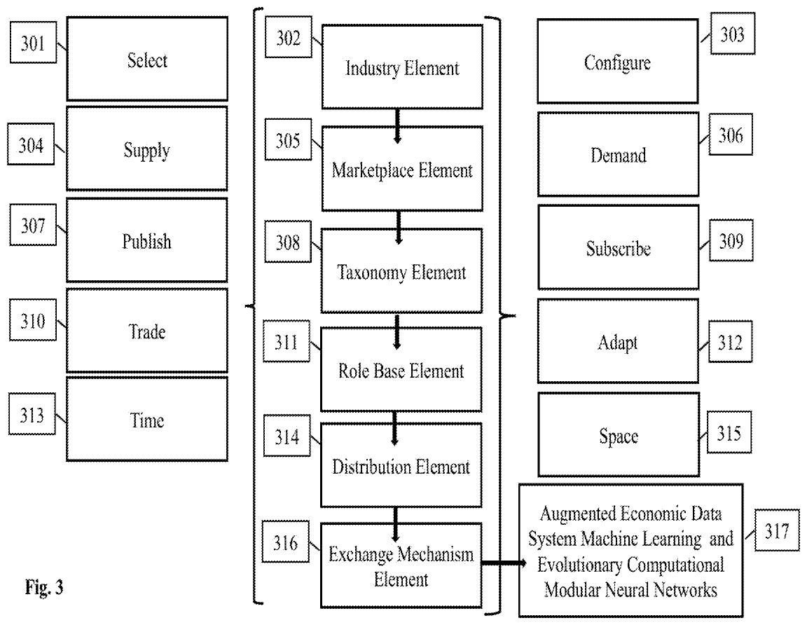

2. In this embodiment, FIGS. 2 201, 202, 203, 204, 205, 206, 207, 208, 209, and 210 shows alternating base paired data configuration protocols; that integrate and interact with the adaptive, emergent and evolutionary dynamic network architecture elements; to apply different contextual data stimuli; and generate adaptive, emergent and evolving multi-access inter-networking economic data block(s) as shown in FIG. 3; encompassing said economic data block(s) data, structures, dimensions, connections, relationships, exchange mechanisms, including context, location and utility, over time and space, among other examples.

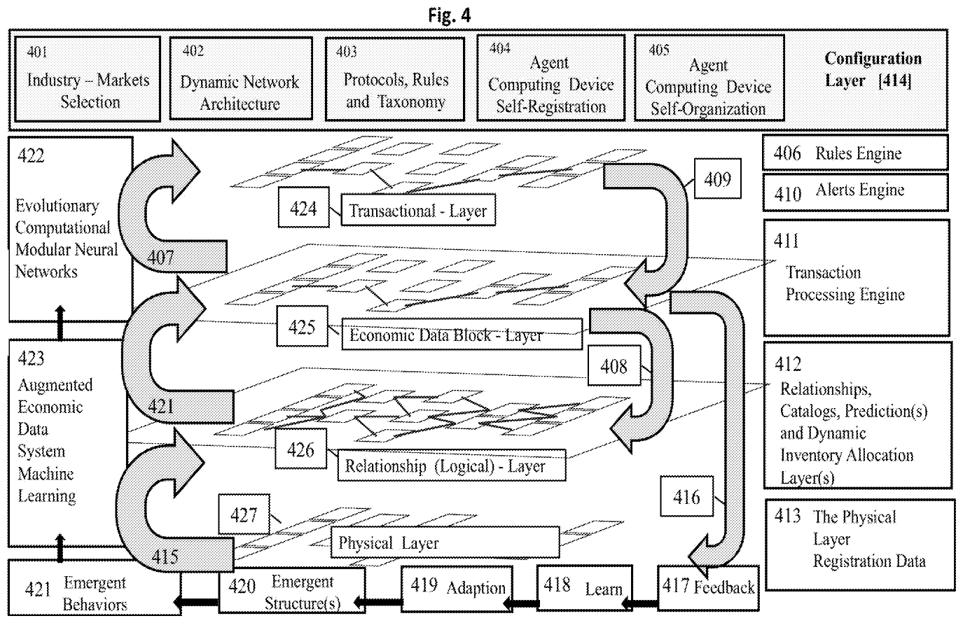

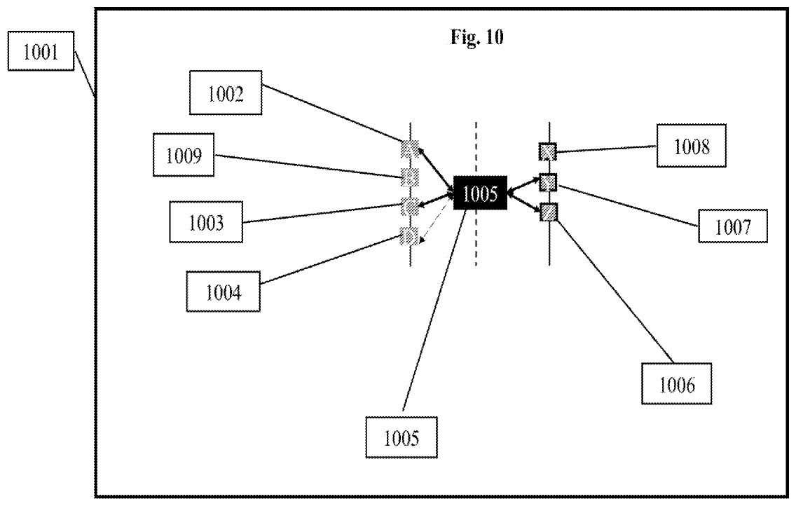

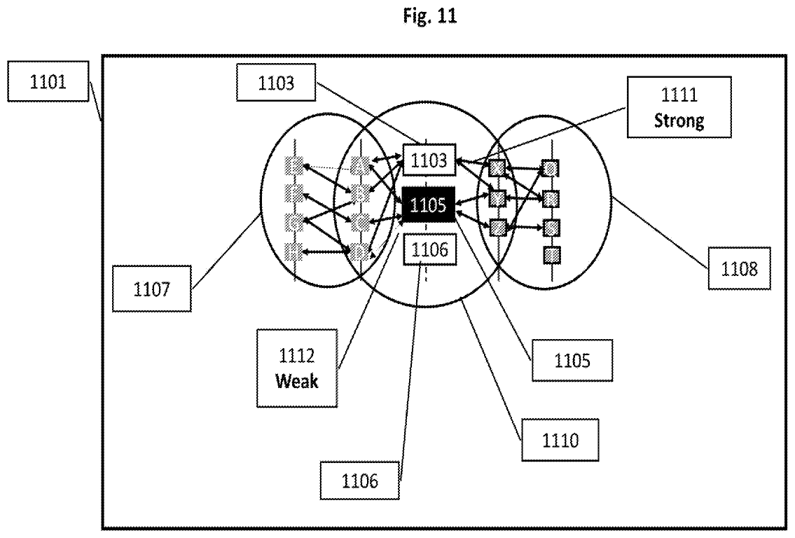

3. In this embodiment, FIG. 3 shows the combination of dynamic network architecture elements from FIG. 1 and FIG. 2, these are shown in FIG. 3 as 302, 305, 308, 311, 314, 316 and the data configuration protocols from FIG. 2 are shown in FIG. 3 as 301, 303, 304, 306, 307, 309, 310, 312, 313, 315]. The elements combine, sequence, mutate and recombine through the process of curation to create multi-access economic data block data, structures, dimensions, connections, relationships, exchange mechanisms, including context, location and utility; that enable the self-registration and self-organization processes shown in FIGS. 7 702 and 703, and FIG. 10 and FIG. 11, which create an operable evolutionary economic data system as shown in FIG. 4, for said plurality of self-organizing supply and/or demand agent computing devices and their related dynamic data, structures, dimensions, connections, relationships, exchange mechanisms, including context, location and utility, among other examples.

4. In this embodiment, FIG. 4, shows a high level overview of a sequence of steps to select and configure a curated economic data system; enabling said economic data system to support a plurality of self-organizing supply and/or demand agent computing devices operating within dynamic, adaptive, emergent and evolutionary private trading network(s); said private trading network(s) being created, governed, constrained and contextualized by defined adaptive, emergent data, structures, dimensions, connections, relationships, exchange mechanisms, including context, location and utility, as shown in FIG. 3 utilizing the inputs from FIG. 1, industry element 101, marketplace element 102, taxonomy element 103, role base element 104 and 112, distribution element 105, and exchange mechanism element 106, over time and space, among other examples.

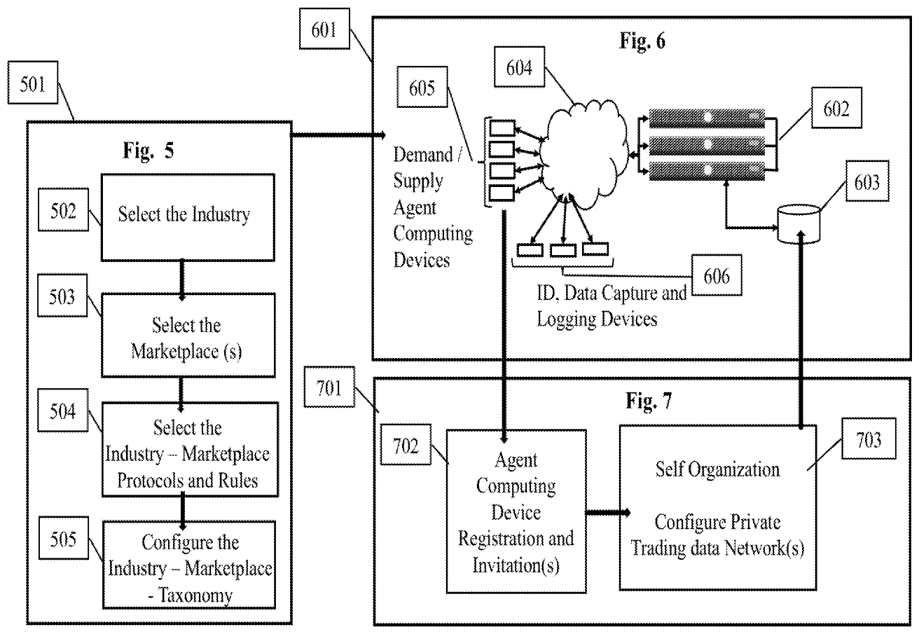

5. In this embodiment, a curation process is shown in FIG. 5 501, and as steps in FIGS. 5 502, 503, 504 and 505; with the output of curation being shown in the configuration layer in FIG. 4 as 414; encompassing the configuration datasets 401, 402 and 403; enabling the economic data system's self-organizing, self-selections and configuration processes shown in FIG. 4 404, 405 for the supply and/or demand agent computing devices as shown in FIG. 6 605 into an operable economic data system as shown in FIG. 4, among other examples.

6. In this embodiment, as shown in FIG. 1 107 the curation process selects, designates and configures the economic data system with specific industry data as shown in FIG. 1 101, marketplace data as shown in FIG. 1 102, taxonomy data shown as shown in FIG. 1 103 and supply and/or demand role base data as shown in FIG. 1 104 and distribution data 105, and exchange mechanism data as shown in FIG. 1 106, among other examples.

7. In this embodiment, the economic data blocks combination, sequence, mutation and recombination of dynamic network architecture elements as shown in FIGS. 3 302, 305, 308, 311, 314, and 316, establish the dynamic rules that create, govern, constrain and contextualize the economic data system, and self-organizing supply and demand agent computing device activity as shown in FIG. 4 configuration layer 414, and the capabilities, capacities and service levels supported in other layers in FIG. 4; physical layer data 413 and physical layer registration data 427, including devices 606, encompassing the relationship (logical) layer 426 and economic data block 425, transactional processing layer 411 and inventory transactions layer 424, and rules engine 406, and alerts engine 410, among other examples.

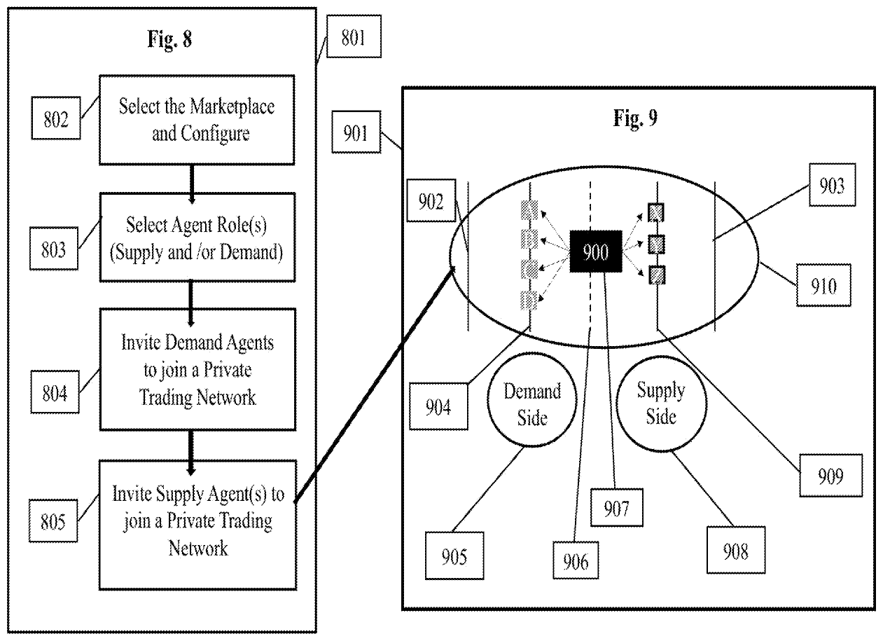

8. In this embodiment, the data, structures, dimensions, connections, relationships, exchange mechanisms, including context, location and utility, which supply and/or demand agent computing devices may self-select and configure as shown on FIGS. 2 201 and 202, utilizing the steps in FIGS. 8 802, 803, 804, and 805, thus enabling said plurality of adaptive, emergent and evolutionary private trading networks to be initiated, created and evolve as shown in FIGS. 9, 10 and 11, which are further enabled to operate dynamically as shown in the relationship, catalog and transaction data in FIGS. 4 411 and 412, with the outputs enabling agent computing device activities in the layers as shown in FIGS. 4 426, 425 and 424, among other examples.

9. In this embodiment, in FIG. 4, the taxonomy 403, and as shown in FIG. 1 103, and as configured in FIG. 3 308, establishes the basis for every contextual layer of adaptive, emergent and evolutionary goods and/or service and/or asset classification data available to be selected as shown in FIGS. 8 802 and 803; constraining what may be configured and applied by the self-registering and self-organizing supply and demand agent computing devices as shown in FIG. 6 605, and in FIG. 9, FIG. 10 and FIG. 11, producing marketplace data, structures, dimensions, connections, relationships, exchange mechanisms, including context, location and utility, within each of the industry data and market data, structures, dimensions, connections, relationships, exchange mechanisms, including context, location and utility, by utilizing the curated dynamic network architecture data elements as shown in FIGS. 1 101, 102,103 and 107, among other examples.

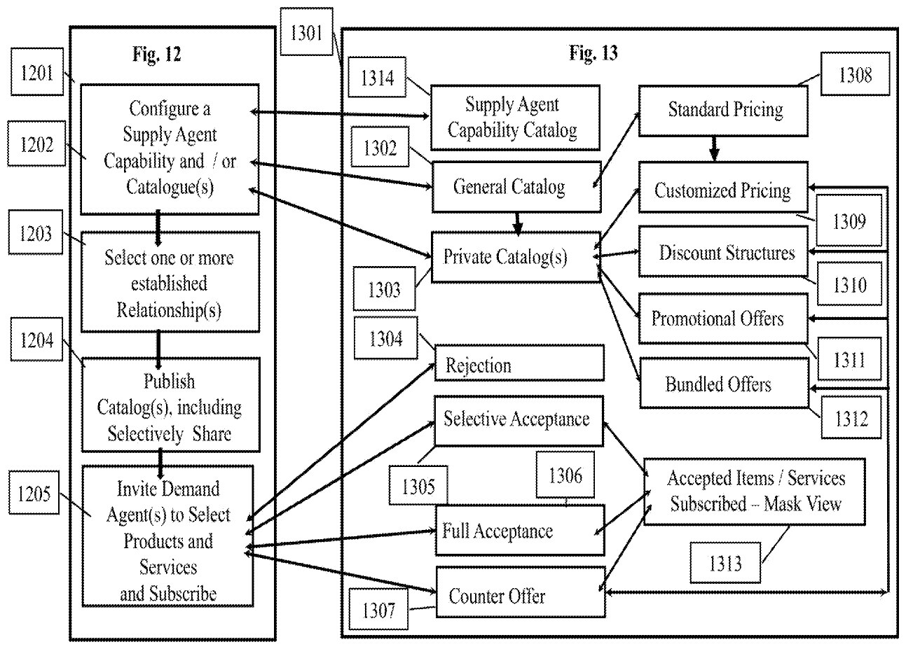

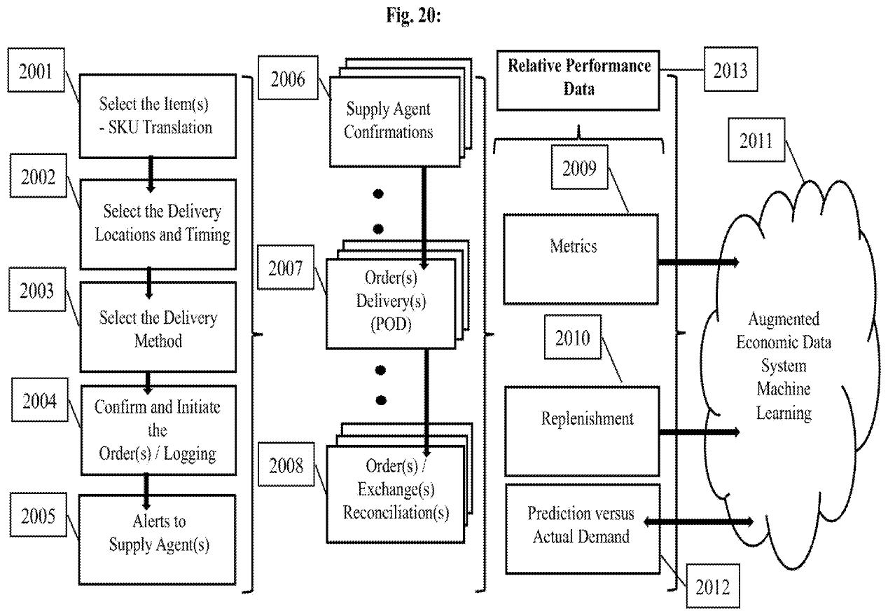

10. In this embodiment, the alternating base paired data configuration protocols shown in FIG. 2 and the rules and protocols as shown in FIGS. 1 108, 111 and 110, create, govern, constrain and contextualize the who, what, when, why, where and how self-organizing supply and demand agent computing device roles, connections and relationships that may be configured and established within an economic data system as shown in FIGS. 1 109, 112 and 113 and FIG. 4 412 and FIGS. 8 804 and 805, and what contextual data may, or may not, be published and subscribed to, being constrained as shown in FIGS. 1 112, 113 and 114, and in FIG. 4 412 to create the relationship logical layer shown in FIG. 4 426, the economic data block layer 425, and enabling the transactional layer 424 utilizing the processes described in FIGS. 12 1202, 1203, 1204 and 1205, and recording the activities as shown in FIGS. 4 411, and 421, and concurrently enabling a plurality of contextual trade interactions and multi-dimensional many-to-many feedback loops as shown on FIGS. 4 415, 412, 407, 409, 408 and 416, and in FIG. 20 between the plurality of self-organizing, supply and/or demand agent computing devices registered on the economic data system as shown in FIGS. 4 404 and 405, to create the data, structures, context, location and utility predictions and outcomes as shown in FIG. 4 412, 416 with feedback 417, utilizing computing devices/apparatus as shown in FIG. 6 605 over a network 604, to computing apparatus(s) 602, and database(s) 603, among other examples.

11. In this embodiment, self-registration and self-organization and the establishment of private trading networks by supply and/or demand agent computing devices is shown on FIGS. 4 404 and 405, and utilizing processes shown in detail in FIG. 7 and FIG. 8. Self-registration and self-organization establishes, and may update, the relationships as shown in FIG. 4 as 412 which are stored in the relationship (logical) layer 426, said relationships being created, and allowed to evolve as shown in detail in FIG. 9, FIG. 10, and FIG. 11, among other examples.

12. In this embodiment, said economic data system is built upon, and uses a plurality of separate but interrelated computational engines as shown in FIG. 1 111, 117, 118 and FIGS. 4 406, 410, 411 and 412, with each computational engine operating at a different architecture layer, a representation of one embodiment of the layer structure is shown in FIG. 4 424, 425, 426 with an abstraction of the physical world in the layer 427 with registration data stored as shown in 413 and the database 603, among other examples.

13. In this embodiment, the economic data system is created, governed, constrained and contextualized by the alternating base paired data configuration protocols, rules and taxonomy established during curation as shown in FIGS. 1 107 and 108, and as shown in FIGS. 4 401, 402, and 403, these being stored in the configuration layer 414, among other examples.

14. In this embodiment, the curation process to establish the system configuration is shown in overview in FIG. 1, and as a process in FIG. 5 as 501, 502, 503, 504, 505 utilizing the alternating base paired data configuration protocols in FIG. 2, and the adaptive, emergent and evolutionary dynamic network architecture elements described in FIG. 1, among other examples.

15. In this embodiment, the selections made in the steps in curation shown in FIG. 5 501 utilizing the data in FIGS. 3 302, 305, 308, 311, 314, and 316, creating, governing, constraining and contextualizing the economic data system transaction processing engine as shown in FIG. 4 411, utilizing the data in 412, for the specific industry data/marketplace(s) data/taxonomies data/role based data/distribution data/exchange mechanism data that were initialized in FIGS. 1 101, 102 and 103, 104, 105, 106 among other examples.

16. In this embodiment, once curation is completed and the configuration is initialized, and curation data stored as in FIG. 4 414, the self-registration and self-organizing capability, capacity and service levels shown in FIGS. 4 404 and 405 is enabled utilizing the process shown in FIG. 7 701, and steps 702 and 703 which support the process that creates, governs, constrains and contextualizes the formation of a plurality of sub-set(s) of interrelated, adaptive, emergent and evolutionary private trading networks as shown in FIG. 9 901, being created as shown in FIG. 8 through the process steps 802, 803, 804, and 805, which create a plurality of relationships in the relationship layer shown in FIG. 4 426, and at the economic data system level, and the superset demand-supply network for the defined industry and a plurality of markets as shown in FIG. 11, among other examples.

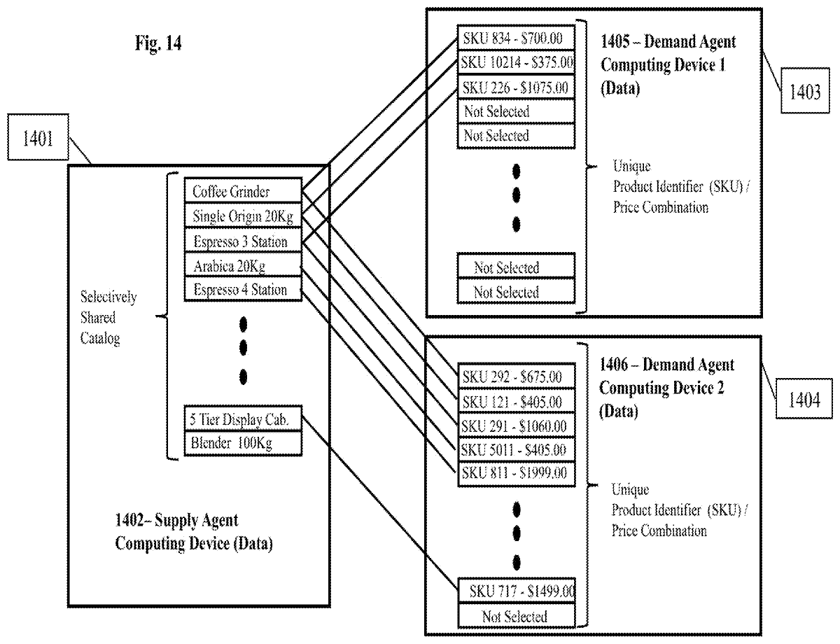

17. In this embodiment, the creation of one instance of a flexible and dynamic private trading network structure is shown for an individual agent computing device in FIG. 9 901, with context based on the computing agent device 907 selected role(s) to the demand side 904 and 905 and supply side 908 and 909 connections, and is functionally analogous to a dynamic mesh network structure and capable of developing as a wirearchy, for a plurality of adaptive, emergent and evolutionary agent computing devices to create data relationships and structures, as shown in FIG. 11, FIG. 12, and FIG. 13, for a plurality of agent computing devices as shown in FIGS. 11 1103, 1105 and 1106, and a wider adjacent marketplace(s) network of adaptive, emergent and evolutionary agent computing devices as shown in 1108 and 1107, where the relative strength or weakness of each trade connection made may be representative of selections and configurations made, and/or volumes, and/or values transacted, and/or traffic data, or any combination thereof, with that characteristic being stored for that specific point in time as shown in 1111 and 1112, among other examples.

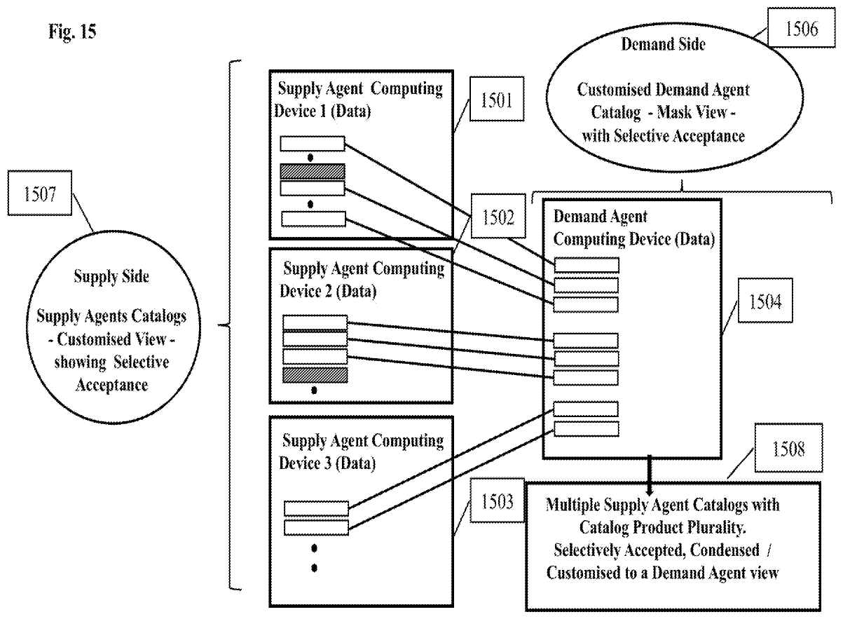

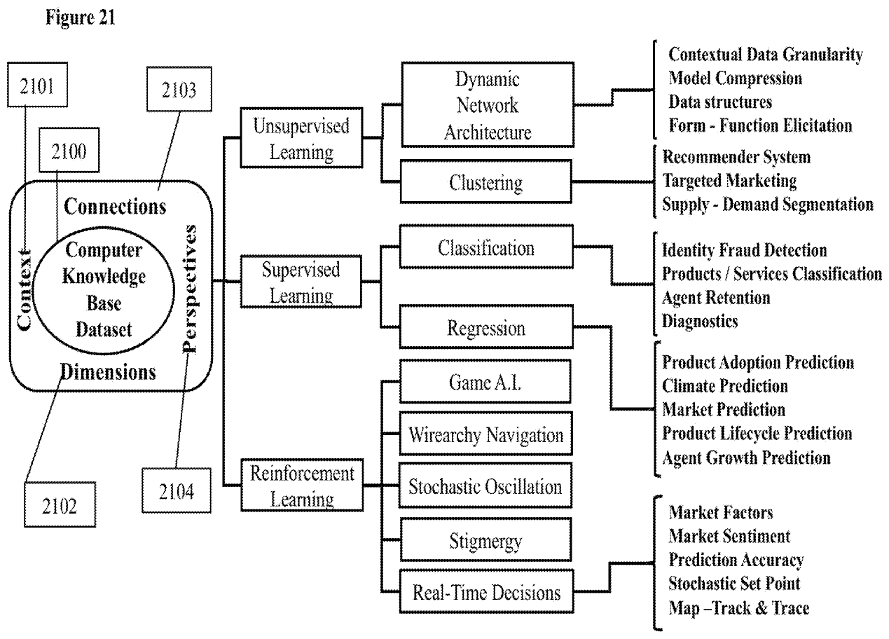

18. In this embodiment, a plurality of adaptive, emergent and evolutionary private trading networks are made available on the economic data system as shown in FIG. 4 and in FIG. 6, said apparatus and economic data system hosting and encompassing a superset of logically possible contextual trade dimensions, connections, perspectives, parameters and utility, which is available for augmented economic data system machine learning and analysis as shown in FIG. 21, utilizing the plurality of subsets of possible and established relationships as shown in FIG. 11 1101, and within each relationship, where related and self-selectable configured catalog(s) data and/or other data types have been created, activated, and exchanged between and among self-organizing, supply and/or demand agent computing devices as shown in FIG. 9 and in the detail in FIG. 12, FIG. 13, FIG. 14, and FIG. 15, among other examples.

19. In this embodiment, utilizing the dynamic network architecture elements in FIG. 1, and the adaptive, emergent and evolutionary economic data block structures they allow, and the demand and/or supply agent computing device selections, interactions and transactions they enable and support; encompassing the adaptation, emergent and evolution of self-organizing agent computing devices data network of connections and relationships and data exchange mechanisms as shown in FIG. 8, FIG. 9, FIG. 10, FIG. 11, FIG. 12, FIG. 13, FIG. 14 and FIG. 15, make the economic data system capable of rapid adaptation, emergence, evolution, and dynamic responses, among other examples.

20. In this embodiment, established private trading network structures as shown in detail in FIG. 9, FIG. 10, and FIG. 11 and the catalog data shown in FIG. 12 and FIG. 13 are allowed to adapt, emerge and evolve over time, driven by feedback and the contextual data activations of self-organizing supply and/or demand agent computing devices in response to said feedback and external data stimuli and changes to the transactional and marketplace data driven by the alternating base paired data configuration protocols in FIGS. 2 203, 204, 205, 206, 207, 208, 209, and 210, among other examples.

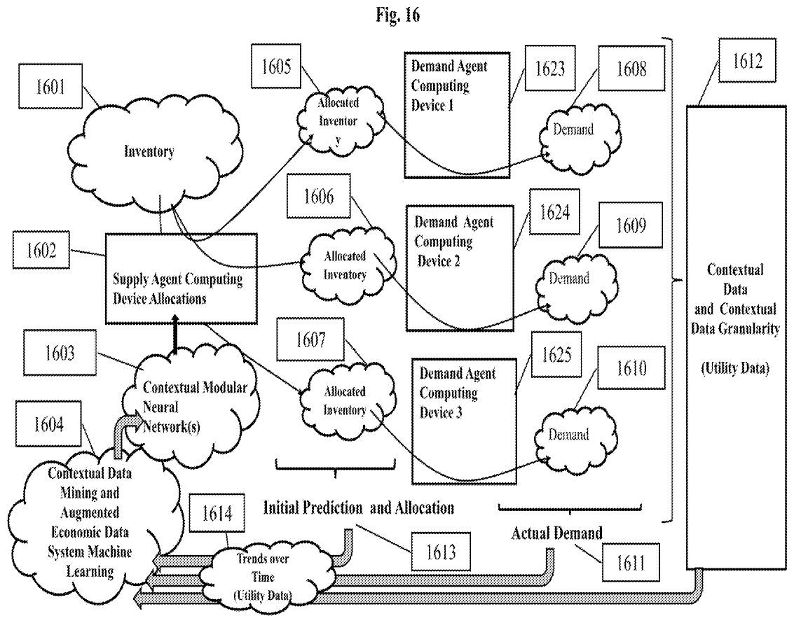

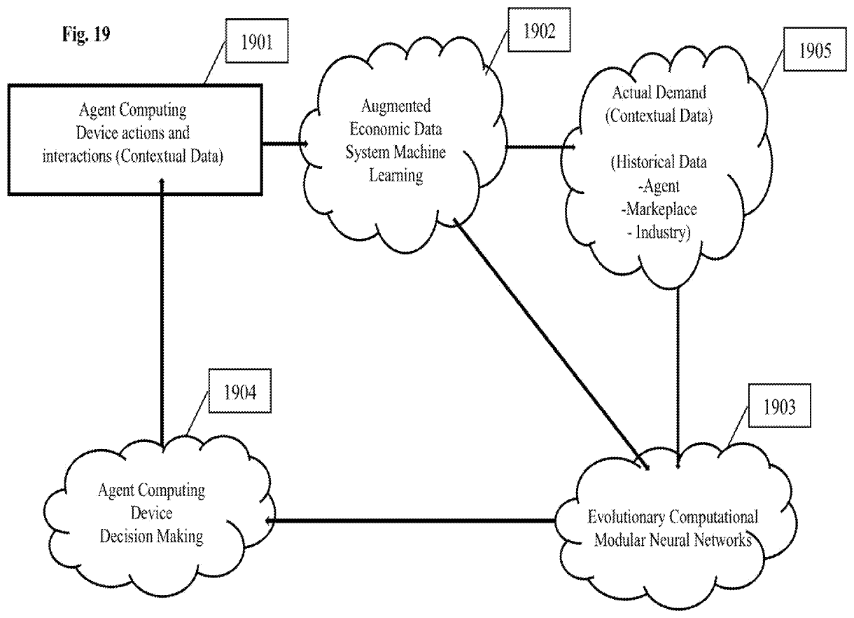

21. In this embodiment, the economic data system shown in FIG. 4, may be configured as shown in FIG. 6 delivers a series of key attributes “ubiquity to the trading network connectivity” with “flexibility, adaptation, emergence and evolution” applied to the establishment of dynamic trading relationships shown in FIG. 4 in the layers 426, 425 and 424, and executing simple and complex free-scale transactions for a plurality of self-organizing, supply and/or demand agent computing devices shown as a plurality of captured interactions in FIG. 4 415, 421, 407 and the feedback shown in FIGS. 4 409, 408 and 416, and those feedbacks ultimately feeding augmented economic data system machine learning and a series of evolutionary computational modular neural networks as shown in FIGS. 4 422 and 423, and FIG. 16, FIG. 18, FIG. 19, and FIG. 20, which drive structural data adaptation, emergence and evolution within the economic data system through said continuous feedback as shown in FIGS. 4 417, 418, 419, 420, and 421, among other examples.

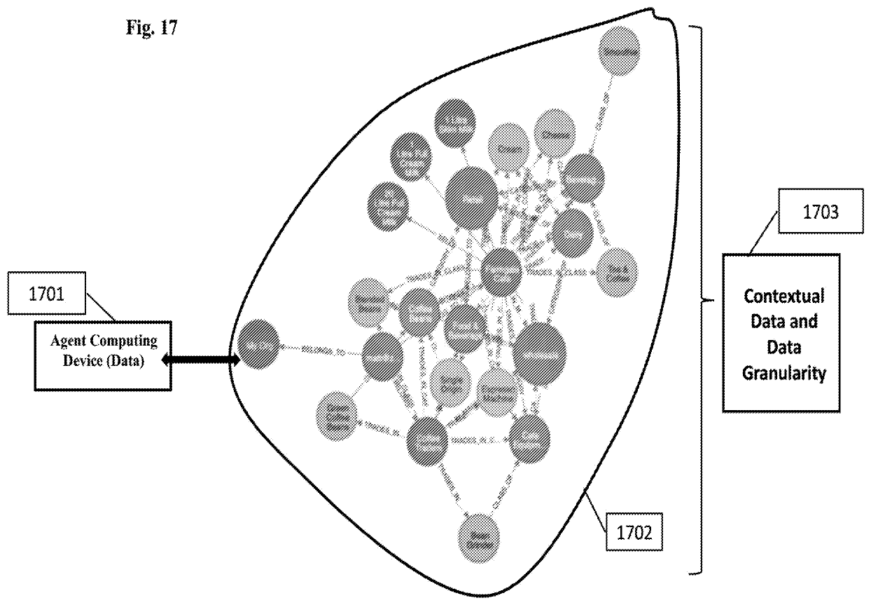

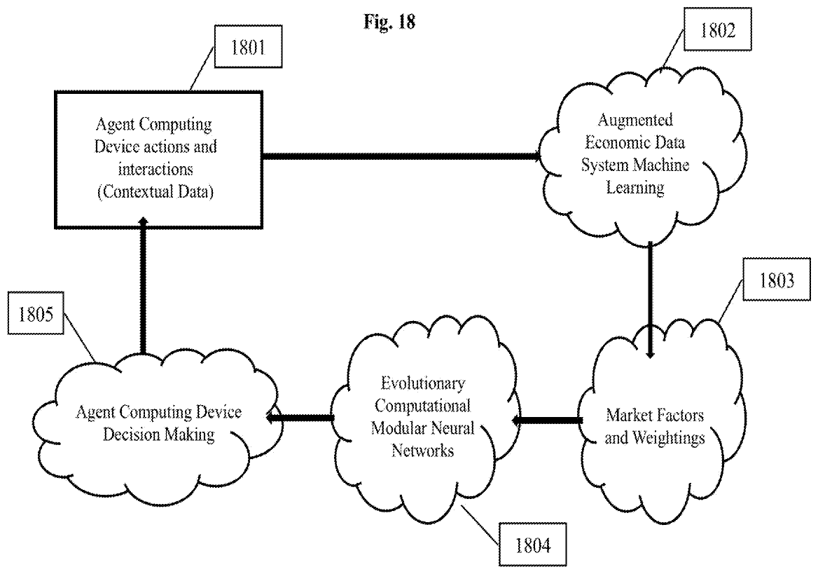

22. In one embodiment, self-organizing supply and/or demand agent computing device relationships in operation is shown in detail on FIG. 9, FIG. 10, FIG. 11; the shared catalog data as shown in detail on FIG. 13, FIG. 14 and FIG. 15; and transactional processes data shown in detail on FIG. 16, FIG. 18, FIG. 19 and FIG. 20; iterate through the operation of the engines shown in FIGS. 4 412, 411, 406 and 410, and the lower level structure as shown in FIG. 4 426, the inventory changes and transactions FIG. 4 424, and feedback data as shown FIGS. 4 421, 407, 409, 408 and 416; and the operational and transactional detail on FIG. 16, FIG. 17, FIG. 18, FIG. 19 and FIG. 20 within the economic data system also continue to adapt, emerge and evolve over time and space, among other examples.

23. In this embodiment, feedback to each of the self-organizing supply and/or demand agent computing devices is continuous as shown in FIGS. 4 416 and 417, FIG. 16, FIG. 18, FIG. 19, and FIG. 20, among other examples.

24. In this embodiment, self-organizing supply and/or demand agent computing device data feedback delivers additional and desirable key attributes; including the ability for each self-organizing supply and/or demand agent computing device and the economic data system as a whole to trade, learn, adapt, emerge and evolve as shown in FIGS. 2 207 and 208, utilizing the mechanisms shown in FIGS. 4 416 and 417 to create emergence and evolution as shown in FIGS. 4 418, 419, 420, and 421, among other examples.

25. In this embodiment, the economic data system supports and enables supply and/or demand agent computing devices to self-organize utilizing select and configure, and to subsequently modify and adapt, their private trading network(s) as a subset within the economic data system. This capability is enhanced by the application of, and feedback from, augmented economic data system machine learning as shown in FIG. 4 423 and computational modular neural networks as shown in FIG. 4 422, in support of predictive decision making, as shown in FIG. 18 and as shown in FIG. 19, among other examples.

27. In this embodiment, the dynamic network architecture being utilized by the invention provides a simple and powerful computing technology enabled approach to the design, deployment and concurrent operation of economic data system(s) as shown in FIG. 4, through the selective application of a plurality of alternating base paired data configuration protocols as shown in detail in FIG. 2, among other examples.

28. In this embodiment, the application of the alternating based paired data configuration protocols FIGS. 2 201, 202, 203, 204, 205, 206, 207, 208, 209 and 210 enable each self-organizing supply and/or demand agent computing device; through a logical framework governed by role selection(s) as in FIG. 8 803 and FIG. 1 112 and a rules engine as shown in FIG. 1 111 and FIG. 4 406; to select and configure their own adaptive, emergent and evolutionary private trading network(s) as shown in the agent computing device registration process in FIG. 8 and create said adaptive, emergent and evolutionary private trading networks as shown in FIG. 9, creating the plurality as shown in FIG. 11, and as represented by the layers in FIGS. 4 426 and 425, among other examples.

29. In this embodiment, the agent computing device registration process shown in FIG. 8 and the capability to develop and deploy catalogs, then publish and subscribe as shown in FIGS. 12 1203, 1204 and 1205; coupled with selective acceptance shown in FIGS. 13 1305 and 1307 other the catalog data capabilities as shown in FIG. 13 and in detail in FIG. 14, simplify agent computing device trade exchange data throughput, and enable rapid private trading network creation, adaptation, emergence and evolution, among other examples.

30. In this embodiment, the invention may utilize simple codeless user interfaces and selections to build a complex but dynamic economic data system. An example of the dynamic economic data system and its elements is shown in overview in; FIG. 3, FIG. 4, FIG. 5, FIG. 8, FIG. 9, FIG. 12, FIG. 13, FIG. 16, FIG. 17, FIG. 18, FIG. 19, and FIG. 20; collectively the computer enabled technologies allow the creation of economic data block structures with significant performance and optimization improvements over messaging and/or brokerage based end-to-end trade network approaches and their architectures, among other examples.

31. In this embodiment, the outputs of machine learning may be applied as shown in FIG. 18 1802, to identify and quantify the active market factors as shown in 1803, for any time period, where said outputs may be further segmented to show detail such as: the active market factors, individual market factor weightings, and by applying contextual data filters to the economic data system, obtain an overall market sentiment and/or segmentation within industries, marketplaces, taxonomies, and/or geographies, among other examples.

32. In this embodiment, as shown in FIGS. 17 1701, 1702 and 1703, the data flowing from selections and configurations, relationships, and activities of individual supply and/or demand agent computing devices are stored as contextual data with data granularity and made available for use by that agent computing device, and as an input to machine leaning and as input to the operation of modular neural networks, said data encompassing; relationship and catalog plurality as shown in FIG. 14 and FIG. 15, including selective acceptance, such that the stored data is condensed to an agent computing device view with the application of the economic data system taxonomy to the classification of catalog data sets, for markets, with its related transactional meta-data 1702, among other examples.

33. In this embodiment, the economic data system utilizes augmented economic data system machine learning as shown in FIG. 18 1802 with contextual data mining as shown in FIG. 16 1604 to capture and analyze the economic data system's contextual transactional data interactions as shown in FIG. 16 1612, FIG. 17 1701, 1702, 1703, and FIGS. 18 1801, 1802 and 1803, and FIG. 19 1901 to establish which marketplace data factors were operative as shown in FIG. 18 1802, and their relative weighting for each time period as shown in FIG. 18 1803, and the captured contextual trade dimensions, connections, perspectives, parameters, exchange mechanisms, as shown in FIG. 21, and combining utility and marketplace factor(s) data as shown in FIGS. 16 1612 and 1614 feeds into a series of adaptive, emergent and evolutionary computational modular neural networks, beginning as shown in FIGS. 18 1803 and 1804 to quantify and apply the contextual weightings, for those factors which were identified [as producing the most significant outcomes for each time period, among other examples.

34. In this embodiment, the computer knowledge base dataset; encompassing context, dimensions, connections, perspectives as shown in FIGS. 21 2101, 2102, 2103, and 2104 such that the computer knowledge base dataset may be used in subsequent activity for machine learning and computational modular neural networks as shown in FIG. 19 1903 to support decision making as shown in FIG. 19 1904 by comparing the self-organizing supply and/or demand agent computing devices predictions as shown in FIGS. 16 1605, 1606, 1607 and 1623 with the augmented economic data system machine learning predictions 1604 and modular neural network 1603 and actual demand outcomes as shown in FIGS. 16 1608, 1609, 1610, 1611 and 1612, to establish an overall marketplace data sentiment, as shown in FIG. 18 1803, among other examples.

35. In this embodiment, the computer knowledge base dataset as shown in FIG. 21; encompassing context, dimensions, connections, perspectives, is initiated at curation when the economic data system is initialized and subsequently collates and stores all the configuration and operational data produced as a result of agent computing device activity, which may then be utilized as input to back propagation as shown in FIGS. 18 1802, 1803 and 1804 to determine and improve predictive accuracy of the economic data system predictions and any self-organizing supply and/or demand agent computing devices data predictions with outcomes stored in the computer knowledge base dataset as in FIG. 21 for each subsequent cycle, among other examples.

36. In this embodiment, feedback is made available as shown in FIGS. 18 1804 and 1805, to selected supply and/or demand agent computing devices for the purpose of supporting supply and/or demand agent computing agent device decision making, and the making of inventory predictions, where those predictions (such as supply and/or demand forecasts) may be based on questions such as: What quantity of each good and/or service, and/or asset capability, capacity and service level should be provisioned or ordered?, When should said orders be placed to run a minimum in-stock, What is the probability of a stock out?, What is the offer and the offer pricing relative to the marketplace?, and What is the supply and demand prediction for said offer and pricing?, such that said predictions and any decisions made and/or actions taken by agent computing devices 1801 may then be validated and tested for accuracy in subsequent cycle(s), among other examples.

37. In this embodiment, feedback is made available as shown in FIGS. 19 1902 and 1903, to selected supply and/or demand agent computing devices for the purpose of supporting supply and/or demand agent computing device decision making 1904, and the making of utilization predictions, where those predictions (such as supply and/or demand forecasts) may be based on actual historical data, analysis of trends and/or predictions, to answer questions such as: What are the expected goods and/or services and/or assets time in stock?, What is the expected average or actual time from order placement to completion of any event such as pick, pack, or ship?, What is the appropriate or most effective replenishment strategy based on the variability?, What is the expected and/or actual quote to ship or quote to cash cycle time?, and What is expected and/or actual inventory turn rate and/or services utilization, such that said predictions 1904 and any decisions made 1901 and/or actions taken by agent computing devices may then be validated and tested for accuracy in subsequent cycle(s), among other examples.

38. In this embodiment, as shown in FIGS. 19 1902, 1903 and 1905 combinations, sequences, mutations and re-combinations of historical data at the agent computing device, marketplace and industry level(s) and prediction data may be utilized′ to answer variability questions such as: What are the patterns observed in the inventory and/or services and/or assets and/or allocations, and/or reserve inventory?, What is the more effective inventory strategy, human derived or machine derived?, What is the throughput rate for the warehouse locations and/or distribution and/or the actual and/or anticipated service levels?, What was the variability in predictions versus historical (actual) demand is that prediction accuracy getting better, worse or staying the same?, such that said predictions 1904 and any decisions made and/or actions taken by individual agent computing devices 1901 may then be validated and tested for accuracy in subsequent cycle(s), among other examples.

39. In this embodiment, dynamic feedback and contextual data delivers an immediacy to the marketplace data response(s), and to the decisions made as shown in FIG. 18 1805 and actions taken 1801 and FIG. 19 1901 that allow each self-organizing supply and/or demand agent computing device to receive meaningful insight data into how their actions, or inactions, are being translated into emergent marketplace data conditions; FIG. 16 is an example of activities data outcomes, and through analysis of metrics and trends over time (Utility Data) as shown in 1612 and 1614 the effectiveness of individual self-organizing supply and/or demand agent computing device relationships and inventory allocations as shown in 1612, 1611, 1613, and 1604 and 1603 to drive dynamic and emergent responses, among other examples.

40. In this embodiment, the economic data system collects, indexes, collates and presents contextual data; encompassing the computer knowledge base dataset, context, dimensions, connections, perspectives as shown in FIG. 21 2100, 2101, 2102, 2103, 2104 parameters, service levels and utility data as shown in FIGS. 16 1612, 1614 and 1604 and FIG. 17 1703 and FIG. 19 1901 and may distribute said data to self-organizing supply and/or demand agent computing devices in terms of their relative performance data as shown in FIGS. 20 2009, 2010 and 2013, and using augmented economic data system machine learning as shown in FIG. 16 1604, and computational modular neural networks FIG. 16 1603, where that output may be in the form of inventory optimization and recommendations as shown in FIG. 16 1613 and FIG. 18 1801, 1805 and FIGS. 19 1901 and 1904 for new trade relationships data as shown in FIGS. 11 1111, and 1112, new goods and new services data, and new assets data, as shown in FIG. 12 1201 and FIG. 13 1301, for the purpose of demand supply data optimization, among other examples.

41. In this embodiment, any supply agent computing device may, as shown in FIG. 16. 1602, establish and then allocate all or part of their inventory as shown in FIG. 16 1601; encompassing the total inventory holding, inventory that is available to order and/or inventory that is available to promise, and making said inventory selectively visible to one, or a plurality of demand agent computing devices, and/or allocating any remaining inventory to a reserve (unallocated inventory), among other examples.

42. In this embodiment, the optimization, including reallocations may be applied to dynamic inventory capabilities, capacities and service level(s) data at any time as shown in FIGS. 16 1601, 1605, 1606 and 1607, including introducing new stimuli such as variations to service levels and/or pricing data over time and space as shown in FIGS. 13 1308, 1309, 1310, 1311 and 1312, among other examples.

43. In this embodiment, there is, captured on the economic data system, an augmented economic data system collective intelligence; where a plurality of self-organizing supply and/or demand agent computing devices, each operating independently, will leave a trace within their trading environment as shown in FIG. 16 1612 and FIGS. 17 1701, 1702 and 1703, where that trace may take the form of relationships data, structure data, catalog data, inventory data, goods and/or service and/or asset capability, capacity, service levels data, distribution data, location data and utility data as in FIG. 16 and FIG. 17 and/or trade exchange data as shown in FIG. 20 2006, 2007, 2008, 2009, and 2010, or trends in said data over time and/or space, as shown in FIG. 16 1614, among other examples

44. In this embodiment, the trace of past activities coupled with immediacy in the feedback as shown in FIGS. 4 416 and 417, support stigmergy (indirect coordination), and may drive adaptation 419, emergence 420 and evolution 421 within the economic data system, among other examples.

45. In this embodiment, as shown in FIG. 21 2101, 2102, 2103, 2104, supply and demand agent activity data is collected and stored by context, dimensions, connections and perspectives data, where said data may then be made available for analysis within the economic data system, machine learning and evolutionary computational neural networks; where said analysis and learning may be further segmented by any combination of factors and/or attributes such as relationship(s), traffic analysis, time period, marketplace, taxonomy including combinations of sub-classification(s), geography, volume, value, encompassing seasonal and cyclical variations, context, dimensions, connections and perspectives, among other examples.

46. In this embodiment, the availability and fluidity of contextual data as shown in FIG. 14 and FIG. 15 and FIG. 16 1602 and FIG. 17 1703, and FIG. 18 1801 and FIG. 19 1901, coupled with the ability to create self-organizing, functionally adaptive, emergent and evolutionary private trading networks as shown in FIG. 8 803, 804, 805 and FIG. 9 901, that are free-scale in their interactions and transactions, and adapt, emerge and evolve as shown in FIGS. 4 419, 420, and 421 to produce an emergent operational wirearchy as shown in FIG. 11, and the data as shown in FIG. 17 1702; encompassing adaptive, emergent and evolutionary data structures as shown in FIG. 4 and presented as evolution in the relationship layer 426 and in the content data created and modified in FIG. 4 412 and FIGS. 17 1702 and 1703, among other examples.

47. In this embodiment, the economic data system wirearchy, traffic analysis data and transactional data, as shown in FIG. 1801, and the context, dimensions, connections, perspectives data as shown in FIG. 21 2100, 2101, 2102, 2103, 2104 among other types as shown in FIG. 19 1901 is stored and made available as data input to augmented economic data system machine learning as shown in FIG. 18 1802, FIG. 19 1902 and FIG. 20 2011 to establish data patterns, and identify which marketplace data factors were active and/or inactive, and which were significant as shown in FIG. 18 1803, among other examples.

48. In this embodiment, calculated values for the marketplace factor contextual data weightings, as shown in FIG. 18 1803 and their volatility over time and space is also collated and stored as part of the augmented economic data system machine learning process, among other examples.

49. In this embodiment, the data from the augmented economic data system machine learning as shown in FIG. 18 1802, FIG. 19 1903 and FIG. 20 2011 and FIG. 21 2100, 2101, 2102, 2103, 2104, is used as input to multi-layer evolutionary computational modular neural networks as shown in FIG. 18 1804 and FIG. 19 1903 with the calculated values for the factors and weightings being applied during the initialization and as updates to the supply and/or demand agent computing device stochastic hidden layer contextual data inputs, among other examples.

50. In this embodiment, the contextual data available on the economic data system as shown on FIG. 17, FIG. 18, FIG. 19 and FIG. 20 simplifies the machine learning and evolutionary computational modular neural network input data preparation; driven by the stochastic behavior within said evolutionary computational modular neural networks, and each economic data system demand/or supply data cycle producing a continuous contextual data feedback loop as shown in overview on FIG. 16 and in detail on FIG. 16 1612, FIG. 17 1703, FIGS. 18 1802, 1803 and 1804 and FIGS. 19 1903 and 1904, among other examples.

51. In this embodiment, utilizing the contextual data granularity in the economic data system data inputs and feedback as shown in FIGS. 4 416 and 417 has the effect of requiring no data cleansing prior to input to the evolutionary computational modular neural networks FIG. 4 422, FIG. 16 1603 and FIG. 18 1804, and FIGS. 21 2100, 2101, 2102, 2103, and 2104 and requires fewer learning cycles to refine the self-organizing agent computing device(s), marketplace and industry contextual data weightings initially input during forward propagation, calculation of the cost function and the biases to be applied during back propagation, among other examples.

52. In this embodiment, the output of the evolutionary computational modular neural network data can then be used to develop demand supply data predictions as shown on FIG. 16 1613 and where selected; be dynamically and automatically applied to the allocation of goods and/or services and/or assets, capabilities, capacities and service levels data to the relevant self-organizing supply and/or demand agent computing devices as shown in FIGS. 16 1601, 1602, 1605, 1606 and 1607, among other examples.

53. In this embodiment, the supply and demand data as shown in FIGS. 16 1608, 1609, 1610, and 1611, for the next cycle is captured as contextual data with data granularity 1612 and used with marketplace factor(s) data as shown in FIG. 18 1803 that are viewed as significant in the previous period to evaluate the prediction data accuracy and establish marketplace sentiment and data integrity to provide data to answer question(s) such as: Are the adaptive, emergent and evolutionary self-organizing supply and/or demand agent computing device data predictions over-estimating, accurately estimating, or underestimating the supply, and/or, demand exchange data, relative to past performance and the overall increasing, decreasing, or static marketplace trend data at any particular point in time and/or space, among other examples.

54. In this embodiment, the continuous contextual data feedback as shown in FIG. 4, FIG. 18 and FIG. 19 is used to train the evolutionary computational modular neural networks to adapt, emerge and evolve to current and future marketplace conditions, generated by the stochastic behavior between and among the self-organizing supply and/or demand agent computing devices, among other examples.

55. In this embodiment, the economic data system as shown FIG. 4 may be hosted as shown in FIG. 6 601, configured on at least one shared computing apparatus 602, utilizing at least one computer shared database 603, with the economic data system being accessible via the Internet 604 to a plurality of self-registered, self-organizing supply and/or demand agent computing devices 605, and identification, logging or data capture devices 606, for the purpose of creating and operating within the economic data system a plurality of self-organizing supply and/or demand agent computing device private trading networks as shown for one instance in FIG. 10, and for said plurality as shown in FIG. 11, among other examples.

56. In this embodiment, the economic data system as shown in FIG. 4 is selected and configured as shown in FIGS. 4 401, 402 and 403 with that data stored as shown in the configuration layer FIG. 4 414, with selection of at least one industry, data, structure, context, location and utility as shown in FIG. 1 101, and at least one marketplace, data, structure, context, location and utility 102, and at least one taxonomy, data, structure, context, location and utility 103, by the economic data system curation agent computing device, among other examples.

57. In this embodiment, as shown in FIG. 1, curation 107 incorporates the capability to select, configure, and enable; additional industries, data, structures, context, location and utility; additional marketplaces, data, structures, context, location and utility; additional taxonomies, data, structures, context, location and utility, in addition to the initial selection and configuration, as utilization of the economic data system adapts, emerges and evolves, as shown in FIGS. 4 417, 418, 419, 420 and 421, among other examples.

58. In this embodiment, having selected, designated and configured the industry, data and/or marketplace, data, and/or taxonomy, data as shown in FIGS. 3 302, 305, 308, 311, 314, and 316, the curation agent computing device selectively configures the alternating base paired data configuration protocols as shown in FIG. 2, initiating the rules and rules engine as shown in FIG. 1 111, and the roles 112, storing said selections and configuration within the economic data system as shown in FIG. 4 414, among other examples.

59. In this embodiment, industry and data and/or marketplace and data and/or taxonomy and data, are selected and configured by the curation process as shown in FIGS. 5 501, 502, 503, 504, and 505; whereby the economic data system is made accessible for self-organizing agent computing device registration as shown in FIG. 6 605 and FIGS. 4 404 and 405, and as described in FIGS. 7 701, 702, and 703, and FIG. 8 802, 803, 804, 805, among other examples.

60. In this embodiment, as shown in FIG. 8 801 registration allows each agent computing device to self-select the supply and/or demand role(s) as shown in FIG. 8 803 and create a new and unique identity as shown in FIG. 9 for each agent computing device 900, reference 907 and for each self-organizing supply and/or demand agent computing device and their roles, describing and storing said data on the economic data system as shown on FIG. 6 601, including the logical organization for each self-organizing supply and/or demand agent computing device as shown in FIG. 9 901, and for each unique agent computing device 900 and which other agent computing devices 904 are visible as shown on the demand side in FIG. 9 905, and which other agent computing devices 909 are visible as shown on the supply side in FIG. 9 908, and which agent computing devices are not visible to agent computing device registrant #900 907 as shown in FIGS. 9 902 and 903, among other examples.

61. In this embodiment, registration invokes the selection and application of the economic data system role base data, and where multiple agent computing devices belonging to the same organization are registering, allows the logical and/or hierarchical segmentation of said organizations registering agent computing device capabilities, and the application of the role based access controls as shown in FIGS. 1 104, 112 and 114, among other examples.

62. In this embodiment, each registering self-organizing agent computing device selects at least one marketplace, data, structure, context, location and utility as shown in FIG. 8 802, and at least one supply and/or demand role 803, among other examples.

63. In this embodiment, as shown in FIG. 10 1001, only one marketplace, data, structure, context, location and utility has been shown, however, in other embodiments each registering self-organizing agent computing device may establish a presence, in a plurality of marketplace(s), data, structures, context, location and utility and a plurality of taxonomies, data, structures, context, location and utility, and in different supply and demand data role(s), among other examples.

64. In this embodiment, having selected a role(s) as shown in FIG. 8 803 as a demand agent computing device and/or a supply agent computing device in at least one marketplace, data, structure, context, location and utility as shown in FIG. 9 901 and specifically as at 906 on the economic data system, each registered self-organizing supply and/or demand agent computing device is prompted to invite as shown in FIG. 9 907 other registered or non-registered self-organizing supply and/or demand agent computing devices, through the steps shown in FIGS. 8 804 and 805, and where desired in related adjacent markets as shown in FIGS. 9 905 and 908, to join a private trading network(s), among other examples.

65. In this embodiment, registered self-organizing supply and/or demand agent computing devices receive electronic invitations as shown in FIGS. 8 804 and 805 as an alert through the economic data system, while non-registered self-organizing supply and/or demand agent computing devices receive an electronic invitation with a registration link, among other examples.

66. In this embodiment, the constraints on visibility of self-organizing, supply and/or demand agent computing devices in adjacent markets, data, structures, context, location and utility is configured by the curation process as shown in FIG. 5 501 and stored with its related data in the configuration layer as shown in FIG. 4 414, among other examples.

67. In this embodiment, a registered self-organizing supply and/or demand agent computing device may elect to be visible, or invisible, to other self-organizing supply and/or demand agent computing devices in adjacent marketplace, data, structures, among other examples.

68. In this embodiment, said self-organizing, supply and/or demand agent computing device utilizing said marketplace, data, structures, context, location and utility may elect to remain invisible to all other self-organizing supply and/or demand agent computing devices within the economic data system, except for those self-organizing supply and/or demand agent computing devices with whom there is an established relationship, among other examples.

69. In this embodiment, full visibility of supply and/or demand computing devices, but only in contextually related marketplaces, data, structures, as shown in FIGS. 9 905 and 908 is assumed, unless overridden by the self-organizing supply and/or demand agent computing device making the invitation(s) as shown in FIG. 8 804, 805, among other examples.

70. In this embodiment, as shown in FIG. 9, by the arrows between the self-organizing supply and/or demand agent computing device FIG. 9 907 in one marketplace, data, structure, as shown on FIG. 9 as 906 represent a plurality of invitation(s) sent to other self-organizing supply and/or demand agent computing devices with a visible presence in adjacent marketplaces, data, structures, as shown in FIGS. 9 904 and 909, among other examples.

71. In this embodiment, the demand side is shown in FIG. 9 905, with invited agent computing devices shown grouped as a marketplace plurality on FIG. 9 904, and on the supply side 908 these are shown grouped as a marketplace plurality shown as 909, the arrows show the invitations extended to other registered self-organizing supply and/or demand agent computing devices in adjacent marketplaces, data, structures, by the inviting self-organizing supply and/or demand agent computing device, shown in FIG. 9 as #900 907, among other examples.

72. In this embodiment, as shown in FIG. 9, invitations may be extended by a self-organizing supply and/or demand agent computing device #900 907 to all other contextually related and visible registered self-organizing supply and/or demand agent computing devices as shown in FIG. 9 with a plurality in 904 and 909 visible on the self-organizing, supply and/or demand agent computing device 907, among other examples.

73. In this embodiment, as shown in FIG. 10, each invited self-organizing supply and/or demand agent computing device may fully accept, partially accept, or decline to accept, the invitation sent by another self-organizing supply and/or demand agent computing device, to produce relationships as shown in FIG. 10 1001, among other examples.

74. In this embodiment, an invited self-organizing supply and/or demand agent computing device fully accepting, or partially accepting the invitation, with outcomes as shown in FIG. 10 1002 fully, 1003 fully, 1006 fully and 1007 fully, 1004 partially, establishes a new and unique set of connections with 1005, and the basis for the now connected self-organizing supply and/or demand agent computing device network to exchange data, utilizing the process as shown in FIG. 12 1201, including capability data, catalog data for goods and/or services and/or assets offerings as shown in FIG. 13 1301, among other examples.

75. In this embodiment, the establishment of each new relationship within each private trading network requires the consent of both self-organizing supply and/or demand agent computing devices, and where a relationship is being terminated by either self-organizing supply and/or demand agent computing device only one, these establishment and termination actions are dynamic and may be initiated at any time, among other examples.

76. In this embodiment, the invitations that are not accepted create no connection, or where relationships are terminated after creation, remove the connection to create an outcome as shown in FIGS. 10 1009 and 1008, among other examples.

77. In this embodiment, the agent computing device registration process described in FIG. 8 801, and in detail in FIG. 9, FIG. 10, and FIG. 11 establish the first layer of the dynamic network architecture, elements and data, created within the economic data system as shown in FIG. 4 412 and the relationships (logical) layer as shown in FIG. 4 426, and in the connections in a mesh network-wirearchy as shown in FIG. 11 1101, with emergent data being stored as in FIG. 4 as changes to the relationship layer 426, among other examples.

78. In this embodiment, the data, structures, and relationships, initially created within the economic data system in the layers in FIGS. 4 426, 425, and 424 are not permanently fixed. The relationships and data, and interactions established between self-organizing supply and/or demand agent computing devices are dynamic; being created, governed, constrained and contextualized, by the selective application of alternating base paired data configuration protocols described in FIG. 2 and role selection(s) as shown in FIGS. 1 104 and 112, and rules 111 and relationships data 113 established during curation 107 that adapt, emerge and evolve over time and space as shown in FIG. 9, FIG. 10, with adaptation as shown in FIG. 4 419, to produce emergent structure(s) and emergent behavior(s) as shown in FIGS. 4 420 and 421, among other examples.

79. In this embodiment, at each layer of the economic data system as shown in FIG. 4 426, 425, 424, the relationships and catalogs data 412; including but not limited to data such as goods and/or service and/or asset data, service area (time and space) data, capacity, capability, service levels data, pricing and transactions data, initially established as shown in FIG. 4 as 412, and in detail in FIG. 9, FIG. 10, FIG. 11, FIG. 12 and FIG. 13 between and among self-organizing supply and/or demand agent computing devices are all dynamic; with the economic data system preserving past and present data sets, and supporting predictive iterations, data and context in the database 603, among other examples.

80. In this embodiment, in FIG. 11, a plurality of self-organizing supply and/or demand agent computing devices in other marketplaces data structures shown as 1107 and 1108, some of whom have a relationship with one or more initiating self-organizing, supply and/or demand agent computing devices as shown on FIG. 11 1103, 1105, 1106 are able to establish a plurality of private trading networks, each with its own unique set of relationships, and shared data, including capability and catalog data as shown in FIG. 13 with other self-organizing supply and/or demand agent computing devices in their adjacent marketplace data structures, as shown on FIG. 11 as 1107 and 1108, among other examples.

81. In this embodiment, the industry, data, structures, context, location and utility, the marketplace(s), data, structures, context, location and utility, and the taxonomy, data, structures, context, location and utility are made available and visible to self-organizing, supply and/or demand agent computing devices for selection and configuration; the superset having been selected and configured within the economic data system during curation through the processes shown in FIG. 5 501, with that configuration data being processed and stored on the apparatus as shown in FIGS. 6 602 and 603, and FIG. 4 414, among other examples.

82. In this embodiment, the establishment, adaption, emergence and evolution of each unique set of relationships, as shown in FIG. 11 and FIGS. 4 419 and 420 by individual self-organizing supply and/or demand agent computing devices is created and stored in the economic data system as a plurality of unique and/or meshed and dynamic private trading networks, with each trading network being capable of operating independently, and/or collaboratively and/or competitively, among other examples.

83. In this embodiment, the economic data system supports dynamic selection for a plurality of self-organizing supply and/or demand agent computing devices with a plurality of relationships in a plurality of industry data, structures, context, location and utility, marketplace data, structures, context, location and utility, as shown in FIG. 11, with the ability for said economic data block data, structures, context, location and utility, and their related data to adapt, emerge and evolve over time and space, among other examples.

84. In this embodiment, FIG. 11 shows one aspect of the evolutionary capability, with originating self-organizing supply and/or demand agent computing devices 1103 and 1105 registered in the same marketplace data structure 1110, and where a single new competing supply or demand agent computing device has now joined the economic data system 1106, but that computing agent device has yet to establish relationships, among other examples.

85. In this embodiment, the economic data system selected, designated and configured by curation data stored in FIG. 4 414, and the adaptive, emergent and evolutionary economic data block, structures, context, location and utility are available to all registered self-organizing supply and demand agent computing devices; but the selections, configurations and activations of collaborating self-organizing, supply and/or demand agent computing devices are private and invisible to competing self-organizing supply and/or demand agent computing devices in that marketplace, data, structure, being established by the constraints (limits) on data views as shown in FIG. 1 114, among other examples.

86. In this embodiment, the self-organizing supply and/or demand agent computing device shown in FIG. 10 1005 has established a plurality of relationships with other self-organizing supply and/or demand agent computing devices in adjacent marketplaces, data, structures, context, location and utility, and may now publish and/or subscribe as shown in FIG. 12, among other examples.

87. In this embodiment, new self-organizing supply and/or demand agent computing devices may join at any time, and existing self-organizing supply and/or demand agent computing devices may, within certain restrictions as selected and configured by the industry, data, structures, context, location and utility, and marketplace, data, structures, context, location and utility, and alternating base paired data configuration protocols and the role(s) data, rules data and relationships data established in the selection and configuration process shown in FIG. 1 109 and as shown in FIG. 5 504, leave the economic data system, at any time, among other examples.

88. In this embodiment, self-organizing supply and/or demand agent computing devices with un-discharged obligations as shown in FIGS. 20 2006 and 2007 are required to; either finalize their obligations; or transfer those obligations to a willing alternate supply and/or demand agent computing device, among other examples.

89. In this embodiment, the restrictions applicable to a self-organizing supply and/or demand agent computing device exiting a private trading network, or departing the economic data system, are established during curation, among other examples.

90. In this embodiment, the alternating base paired data configuration protocols, selections and configurations made in FIGS. 5 504 and 505 establish the basis for role(s), rules and relationships data, as shown in FIGS. 1 111, 112, 113 and 114, that create, govern, constrain and contextualize what individual self-organizing supply and/or demand agent computing devices may, and may not, select and configure, and publish and/or subscribe data within the economic data system, among other examples.

91. In this embodiment, a self-organizing supply and/or demand agent computing device is not permitted to view the proprietary demand and/or supply agent computing device private trading networks and/or catalog data established and shared by other self-organizing supply and/or demand agent computing devices inside and/or outside their selected marketplace, data, structures, context, location and utility; or of any other self-organizing supply and/or demand agent computing devices within their selected marketplace, data, structures, context, location and utility, except where there is an established relationship with said agent computing device(s) and constrained by the publish and subscribe process, as shown in FIG. 8 801, and FIG. 12 1201, among other examples.

92. In this embodiment, a self-organizing supply and/or demand agent computing devices is denied access to publish and/or subscribe data to non-related self-organizing supply and/or demand agent computing devices established in non-adjacent marketplace(s), data, structures, context, location and utility, as shown in FIG. 9 as 902 and 903 where the lines appear unpopulated to agent 900 shown as 907 on the Fig., this ensures that a supplier's data and their suppliers data and/or other suppliers data two nodes or more distant, as shown in non-adjacent markets in FIG. 11 within 1107 and 1108, will remain in separate but interrelated private trading networks, among other examples.

93. In this embodiment self-organizing supply and/or demand agent computing devices which have elected to make their presence and goods and/or services and/or assets capability data visible, may be discoverable within the economic data system, as the basis for extending invitations and establishing new relationships as shown in FIG. 8, among other examples.

94. In this embodiment, where a relationship has been established, self-organizing supply and/or demand agent computing devices may publish and/or subscribe to other self-organizing supply and/or demand agent computing devices in adjacent marketplace(s), data, structures, context, location and utility, as shown in FIG. 10 where each unique relationship forms the basis for the publish and subscribe process shown in FIGS. 12 1204 and 1205 and create the detailed data exchange mechanisms as shown in FIG. 13, among other examples.

95. In this embodiment, registered and established self-organizing supply and/or demand agent computing devices are able to publish and/or subscribe data to, and interact with other self-organizing, supply and/or demand agent computing devices that are part of their private trading network at any time as shown in FIG. 12, FIG. 13, FIG. 14, and FIG. 15 with the activities that plurality of self-organizing supply and/or demand agent computing device(s) creating and modifying the layers within the economic data system, as shown in FIG. 4 as 426 and 425, among other examples.

96. In this embodiment, the self-organizing supply and/or demand agent computing device and the processes associated with the creation, development, deployment, sharing, and maintenance of catalog data as shown in FIG. 12 and FIG. 13 for adaptive, emergent and evolutionary goods and/or services and/or assets data configurations may be exchanged utilizing the plurality of relationships established by each self-organizing supply and/or demand agent computing device in the layers, as shown in FIGS. 4 426 and 425, among other examples.

97. In this embodiment, the exchange, adaptation, emergence and evolution of catalog data utilizing the established relationships occurs through the alternating base paired data configuration protocols of publish and/or subscribe as shown in FIGS. 2 205 and 206, and may vary over time and space as in 209 and 210 based on feedback data from 203, 204, 207, 208, among other examples.

98. In this embodiment, the functions available to each self-organizing supply and/or demand agent computing device with a presence, and by extension the context and content of their catalog(s) data is constrained by; the industry element, data, structures, context, location and utility; marketplace element, data, structures, context, location and utility; taxonomy element, data, structures, context, location and utility; role base element, data, structures, context, location and utility, as shown in FIG. 3, and initially facilitated during curation as shown in FIG. 1 107 and the alternating base paired data configuration protocols 108, among other examples.

99. In this embodiment, the alternating base paired data configuration protocols and rules that create, govern, constrain and contextualize the allowed and supported functions and the operations at all the economic data system layers as shown on FIGS. 4 424, 425 and 426 are defined during economic data system curation, and remain dynamic within said economic data system, among other examples.

100. In this embodiment, self-organizing supply and/or demand agent computing devices catalog data may be created, selected, configured and shared through the processes described in FIG. 12 and FIG. 13 and FIG. 14 and FIG. 15; where a plurality of concurrent catalog data as shown in FIG. 13 1301 may be created, governed, constrained and contextualized by goods and/or service and/or assets data, for a specified time and/or space, or specified quantity and/or value data and selectively shared and/or amended at any time, only becoming visible to related agent computing devices when published, among other examples.

101. In this embodiment, the dynamic relationships established through invitation and acceptance between self-organizing supply and/or demand agent computing devices in adjacent marketplace data structures enable the publish role of a supply agent computing device and subscribe role of a demand agent computing device, allowing the catalog data stored within the economic data system to be deployed and utilized selectively as shown in FIG. 13 and FIG. 14, among other examples.

102. In this embodiment, FIG. 13 1301 presents an overview of the catalogs, 1302, 1303, 1304, 1305, 1306, 1307, 1308, 1309, 1310, 1311, 1312 and 1313 presents the publish and subscribe catalog data sets that produce evolving outcomes, among other examples.

103. In this embodiment, there is a paired relationship created and visible in the relationship logical layer data structures FIG. 4 426 based on the role, rules and relationships each self-organizing supply and/or demand agent computing device has selected within a marketplace, data, structures, context, location and utility, and taxonomy, data, structures, context, location and utility, among other examples.

104. In this embodiment, the alternating base paired data structure as shown in FIGS. 2 203 and 204 establishes for each data relationship a connection channel for communications on that channel and for transaction processing on that self-organizing supply and/or demand agent computing device relationship, where these relationships and role base data sets are established for each self-organizing supply and/or demand agent computing device, during the registration processes, as shown in FIG. 8, among other examples.

105. In this embodiment, as shown in FIG. 9, a self-organizing supply and/or demand agent computing device in one marketplace, data, structure, context, location and utility may also be a self-organizing supply and/or demand agent computing device in adjacent marketplace(s), data, structure, context, location and utility as represented in FIG. 9 by the demand side 905 and supply side 908 designation, noting that “demand side” and “supply side” is relative to the selected role and produces a mirrored pair within each established relationship, among other examples.

106. In this embodiment, a demand agent computing device in one marketplace, data, structure, context, location and utility may also be a self-organizing supply agent computing device in another marketplace, data, structures, context, location and utility, and by logical extension a plurality of marketplace(s), data, structures, context, location and utility, that may be concatenated within the economic data system to produce extended and interconnected network(s) consisting of a plurality of linked private trading networks as shown in FIG. 11, through the relationships established by individual agent computing devices as shown with 1103 and 1105, and as extended by a plurality of other agent computing devices as in 1107 and 1108, among other examples.

107. In this embodiment FIG. 10 shows an individual self-organizing supply and/or demand agent computing device 1005, in one marketplace, data, structures, context, location and utility, where some relationships are connected strongly 1002, 1003, 1006 and 1007 and in FIG. 11 1111, and others weakly 1004 and FIG. 11 1112, and others with no relationship as shown in FIGS. 10 1009 and 1008, where these relationships are allowed to adapt, emerge and evolve over time and space thereby producing contextual data, and making said data available for machine learning, among other examples.

108. In this embodiment, the adaptive, emergent and evolutionary economic data block structures, connections, relationships and utility so produced, as shown in FIG. 10 within the economic data system are able to adapt, emerge and evolve with the plurality of agent computing devices stochastic data inputs and/or outputs, as shown in FIG. 11, and are analogous to a wirearchy-mesh network, among other examples.

109. In this embodiment, the structures, relationships, catalogs and transactions data, and their trends over time and/or space, represent singular aspects of a time series plurality of supply and/or demand agent computing device stochastic inputs and/or outputs as shown in FIGS. 16 1602, 1605, 1606, 1607, 1613 and 1614 are stored and made available to the augmented economic data system machine learning and evolutionary computational modular neural network(s) capabilities within the economic data system, as shown in FIG. 18 and FIG. 19, among other examples.

110. In this embodiment, where a demand agent computing device and a supply agent computing device trade data relationship has been established, a channel is created whereby each supply agent computing device may at any time, create and selectively share, or revoke a plurality of data types, including one or more catalog data sets as shown in FIGS. 13 1302 and 1303 with their related demand agent computing devices, either collectively, such as one general catalog data 1302 shared with all demand side agent computing devices and/or as a plurality of private customized catalog data views shared with selective individual supply side agent computing devices 1303, encompassing private catalog data of the form described in 1309, 1310, 1311, and 1312, as the basis for new transactional data as shown in FIG. 20, among other examples.

111. In this embodiment, a supply agent computing device as shown in FIG. 12 1202, may create general catalog and/or customized pricing and/or discount structure data views, and/or promotional offer views, and/or bundled offers, or any combination thereof as shown in FIG. 13 1301, which may then be selectively published as in FIG. 12 1204, among other examples.

112. In this embodiment, as shown in FIG. 13, any variations from the general catalog data 1302 and standard pricing data 1303 may be derived to create a plurality of private catalog data views 1309, 1310, 1311, and 1312, among other examples.

113. In this embodiment, FIG. 14 and FIG. 15 show a plurality of catalog data customized and condensed to a single time and/or space view. This customized data view is achieved through supply and/or demand agent computing device publish and/or subscribe customized views, where time and/or space limits for acceptance and usage may also be applied, among other examples.

114. In this embodiment, the self-organizing supply and/or demand agent computing device data views, allows for bi-directional customized views of a plurality of unique demand side catalog data as in FIGS. 15 1504 and 1506 for the plurality of supply side catalog data as in FIG. 15 1507 encompassing a plurality of supply agent computing device(s) data 1501, 1502 and 1503, supporting a plurality of transaction processing capabilities, without the duplication of that data, as shown in FIG. 14 1401 for supply agent computing device 1402 and in 1403 for demand agent computing device 1 1405 and in 1404 for demand agent computing device 2 1406, and in FIG. 15 for supplier 1 agent computing device 1501, supplier 2 agent computing device 1502, supplier 3 agent computing device 1503, and on the demand side 1505 for demand agent computing devices 1504, among other examples.

115. In this embodiment, the use of supply and/or demand agent computing device bi-directional customized catalog data with selective views, simplifies the administration of catalog data and pricing data for supply and/or demand agent computing devices, FIG. 14 1402 illustrates the customized view enabled representation of the same item with unique stock keeping unit (SKU) data, among other examples.

116. In this embodiment, where demand agent computing devices subscribe to at least one item from at least one catalog data from at least one supply agent computing device, the demand agent computing device may use their supply and/or demand agent computing device customized view to assign their own unique catalog data item identifier (stock keeping unit data—goods descriptor data) to each accepted item data published and subscribed as shown in FIGS. 14 1402 and 1403, simplifying the catalog data administration for the plurality of supply agent computing devices and/or demand agent computing devices, among other examples.

117. In this embodiment, subsequent transactions involving a catalog data item, where a demand agent computing device allocates a unique id (stock keeping data unit and/or goods and/or service and/or asset descriptor data and/or other data combination) may create a demand view cross reference which may be different from the supply agent computing device view as shown in FIGS. 14 1401, 1403 and 1404 while supporting bi-directional data translation during transaction processing, among other examples.

118. In this embodiment, the alternating base paired data configuration protocols from FIG. 2 establish that any selection or transaction as shown in FIGS. 4 412 and 411 involving a data item will automatically apply the relevant stock keeping unit/descriptor translation based on the direction of that enquiry, offer or proposal, catalog data update or transaction; this is shown for a plurality on the supply side in FIG. 15 1507, and a plurality of agent computing devices on the demand side FIGS. 14 1403 and 1404 and for a single demand agent computing device in FIG. 15 1504, among other examples.

119. In this embodiment, the economic data system applies the supply and/or demand agent computing device customized data views and enables any required translation to the relevant stock keeping unit/descriptor on both the demand side and the supply side agent computing devices, so any transaction (with a plurality of item selections) as shown in FIG. 20 2001 remains recognizable to both the demand agent computing device as in FIG. 15 1504, and the supply agent computing device as in FIGS. 15 1501, 1502, and 1503, with said data and its context being stored and accessible for use by augmented economic data system machine learning and evolutionary computational modular neural networks, among other examples.

120. In this embodiment, FIG. 15 shows the shared catalog data, customization data views applicable to a single demand agent computing device 1504, with a plurality of supply agent computing device relationships, selectively accepting a plurality of items from a plurality of individual supply agent computing devices 1501, 1502, and 1503, such that the demand agent computing devices data set from the plurality of supply agent computing device catalog(s) data may be condensed into a single catalog view 1508 containing a plurality of items from a plurality of supply agent computing devices data which may present with different SKUs as shown in FIG. 14, among other examples.

121. In this embodiment, as shown in FIG. 16 a supply agent computing device 1602 may selectively allocate inventory, capabilities, capacities and availabilities data to a plurality of demand agent computing devices; shown as 1605 for demand agent computing device 1 1623, 1606 for demand agent computing device 2 1624 and 1607 for demand agent computing device 3 1625, to create contextual data and contextual data granularity (utility data) as shown in FIG. 16 1612, among other examples.

122. In this embodiment, the allocation of goods and/or services and/or assets inventory capability, and/or capacity and/or service levels data may be a logical and/or physical representation as shown in FIG. 16 1601, or combinations of both, within the economic data system, where the physical or virtual allocation of said inventory capabilities, capacities and service levels data establishes within the catalog customized view, a dynamic indication of items with the status encompassing service levels data such as “available to order” and/or “available to promise”, making said data visible to demand agent devices as shown in FIGS. 16 1605 and 1623, and enabling the recording of demand as in 1608, and/or supply data transactions as shown in overview on FIG. 20, and simultaneously decrementing said allocated inventory data for any plurality of demand/or supply transactions, as shown in FIGS. 16 1611 and 1613, and recording the trends as shown in FIG. 16 1614, among other examples.

123. In this embodiment, the stochastic inventory data allocation established by each supply agent computing device is made immediately visible to each related demand agent computing device, who may then initiate transactions on that inventory data, through the shared catalog(s) data, to create the actual demand as shown in FIGS. 16 1608, 1609, 1610 and 1611, among other examples.

124. In this embodiment, each transaction logically decrements allocated inventory within the economic data system as shown in FIG. 16 1611, providing a continuous and contextual data feed for economic data system machine learning as shown in FIG. 16 1604, allowing dynamic inventory allocations and/or re-orders and/or re-allocations, from the total allocated inventory data 1601, including supporting dynamic replenishment of, or reallocation within that inventory data, among other examples.

125. In this embodiment, the economic data system supports the creation, capture, consolidation and deconsolidation, storage, and dissemination of the plurality of demand selections, configurations and trade data transactions with a plurality of catalog data items, and the explosion of trade data transactions as shown in FIG. 20 2006, 2007, 2008, from a plurality of business data taxonomies, from a plurality of goods and/or services and/or assets supply agent computing devices; that may include a plurality of logistics providers, and a plurality of distribution centers, delivering to a plurality of locations across a plurality of times and space as shown in overview in FIG. 20, making said contextual data available to augmented economic data system machine learning as shown in FIG. 20 2011, among other examples.

126. In this embodiment, as shown in FIG. 15 1506 and FIG. 13 1301, a demand side agent computing device may configure a composite data catalog through selective acceptance 1305, comprising all 1306, or part, of the supply agent computing device data catalog(s) that have been published to, and selected by the demand agent computing device, among other examples.

127. In this embodiment, as shown in FIG. 15, a demand agent computing device may access, configure, consolidate and procure a plurality of goods and/or services and/or assets data, from a plurality of supply agent computing devices, in a plurality of goods and/or services and/or asset data taxonomies; a demand side agent computing device may execute the consolidated orders in one trade comprising many individual transactions, among other examples.

128. In this embodiment, as shown in FIG. 20, a demand side agent computing device's consolidated orders and post trade data transaction(s) may be automatically de-consolidated and selectively apportioned to each relevant supply side agent computing device(s), without losing the context and integrity of the demand side agent computing device's consolidated order, among other examples.

129. In this embodiment, a high level view of the components, selections and data configurations for an executed consolidated transaction is shown in FIGS. 20 2001, 2002, 2003, 2004, and 2005, among other examples.

130. In this embodiment as shown in FIG. 20, the data being created, stored, transacted and collated at each cycle retains its context and is captured by the economic data system as shown in FIG. 16 1612, and as contextual granular data as shown in FIGS. 20 2006, 2007, 2008 and 2009, and made available for subsequent processing and analysis as shown in FIGS. 18 1801, 1802, 1803, 1804, and 1805 and FIGS. 19 1901, 1902, 1903 and 1904 where that data may be stored by individual self-organizing supply and/or demand agent computing devices, among other examples.

131. In this embodiment, the contextual data from each economic data system layer carries with it all the related meta-data as shown in FIG. 17 1701, 1702, 1703 and requires no cleansing prior to its input to augmented economic data system machine learning as shown on FIG. 18, FIG. 19, and FIG. 20, and FIG. 21, among other examples.

132. In this embodiment, the extended logical relationships formed within private trading networks, supporting trade data transaction processing capabilities, are established and adapt, emerge and evolve at every layer; wherein the economic data system captures each change and the dynamic state response as a time-series input to augmented economic data system machine learning as shown FIG. 16 1614 and FIGS. 21, 2100, 2101, 2102, 2103 and 2104, and at the economic data system level as shown in FIGS. 4 415 and 421 and 407, among other examples.

133. In this embodiment, at each iteration, all the current active relationships, data, catalogs data, queries, and/or trade data interactions executed by, or declined by, each individual supply and/or demand agent computing device is stored with its meta-data to deliver contextual data granularity as shown in FIG. 16 1612, FIG. 17 1703, FIG. 18 1801, and FIG. 19 1901 for the plurality of layers for that time and space period, among other examples.

134. In this embodiment, inventory data encompassing information such as the data trends over time are also captured as shown in FIGS. 16 1613, 1614 and 1611, and made available for augmented economic data system machine learning as shown in FIG. 16 1604, among other examples.

135. In this embodiment, FIG. 17 provides a graphical representation of one set of the possible meta-data and taxonomy data 1702 available to a single supply and/or demand agent computing device, at one layer, one relationship, or one catalog, at one point in time, among other examples

136. In this embodiment, supply and/or demand agent computing device and economic data system level contextual data flows continuously, establishing the relative strength and value created by the summation of the trade data transactions for self-organizing supply and/or demand agent computing devices as shown by the relative weights, strength, volume, value and trend of the relationships data as shown on FIG. 11 with 1111 being strong, and 1112 being weak, where traffic analysis as shown in FIG. 18 1801 is input to augmented economic data system machine learning as shown in FIG. 18 1802 and FIG. 4 423, among other examples.

137. In this embodiment, the superset of contextual data represents the inputs and/outputs, captured over time and space, for the selections and configurations and performance of the registered self-organizing supply and/or demand agent computing devices shown on FIGS. 4 408, 409 and 416, allowing insights and inference to be drawn about the past, present and predictive iterations activity data on the economic data system as shown in FIGS. 4 415, 421 and 407, and from the computer knowledge base dataset as shown in FIG. 21, among other examples.

138. In this embodiment, as shown in FIG. 16 1604, FIG. 18 1802, FIG. 19 1902 and FIG. 20 2011 augmented economic data system machine learning and the application of a plurality of evolutionary computational modular neural networks as shown in FIG. 16 1603, FIG. 18 1804 and FIG. 19 1903 using past and current data, enables timely, meaningful and verifiable inferences to be made about the future performance probabilities and behaviors of registered and non-registered self-organizing supply and/or demand agent computing devices, and for inferences to be drawn regarding the wider industry data and/or marketplace data over those same time periods, and selectively shared with registered supply and/or demand agent computing devices as shown in FIGS. 4 415 and 423, among other examples.

139. In this embodiment, examples of inferences being drawn is shown in FIG. 18 1803, and how inference data is made available as stimuli to the decision making as shown in FIG. 18 1805 and FIG. 19 1904, and FIG. 20 2012, among other examples.

140. In this embodiment, FIG. 18 and FIG. 19 provide examples of augmented economic data system machine learning applied to recognize and understand the trades, data, patterns, trends, and the data drivers of those trends in the observed behaviors, the strength of the relationships, the performance of supply and demand agent computing devices, the structure of private trading networks, and the operative market data factors over time and space as shown in FIGS. 18 1801 and 1803, FIG. 19 1901; encompassing the wirearchy behavior as shown in FIG. 11 1101, the data created and shared as shown in FIG. 12 1201 and FIG. 13 1301, and transactions attempted and/or processed as shown in FIG. 20 2012, among other examples.

141. In this embodiment, the augmented economic data system machine learning and a plurality of evolutionary computational modular neural networks as shown in FIG. 16, FIG. 18, and FIG. 19 are used to support and test predictions as shown in FIG. 16 1613; demand management selection data as shown in FIGS. 16 1608, 1609 and 1610; inventory data and inventory management data as shown in FIGS. 16 1601, 1605, 1606, and 1607, and provide stimuli in terms of relative performance such as strength, weakness, volume, and value of trade relationships data as shown in FIG. 11, and contextual data as shown FIG. 18 1801 and FIG. 19 1901, driving goods and/or services and/or assets, distribution and pricing data recommendations as shown in FIG. 18 1805, to create varied data offers as shown in FIGS. 13 1303, 1309, 1310, 1311 and 1312 and enable optimization as shown in FIG. 18 1805 and FIG. 19 1904, among other examples.

142. In this embodiment, FIG. 16, FIG. 18, FIG. 19, and FIG. 20, demonstrates how feedback may be applied to predictions, testing demand management accuracy data, and the inventory optimization data needs of each supply and/or demand agent computing device as shown in FIG. 16 1601, FIG. 18 1805 and FIG. 19 1904, among other examples.

143. In this embodiment, in each cycle, the output of augmented economic data system machine learning establishes and re-establishes the marketplace data factors for the economic data system, as shown in FIG. 18 1803 which are and/or were active at each layer and the relative impacts of those factors on self-organizing supply and/or demand agent computing device performance and emergent behavior as shown in FIG. 4 421, among other examples.

144. In this embodiment, as shown in FIG. 18 1803 a plurality of data such as marketplace factors and contextual data weightings are calculated from contextual data stored in the economic data system as shown in FIG. 4 423; encompassing the cumulative activity of registered self-organizing supply and/or demand agent computing devices; with a representative statistically significant data characteristic being established for the economic data system, data, structures, dimensions, connections, relationships, perspectives, parameters, exchange mechanisms, including context, location and utility; where at least one industry, marketplace(s), and/or taxonomy, data, structures, dimensions, connections, relationships, perspectives, parameters, exchange mechanisms, including context, location and utility; is representative of the superset of registered self-organizing supply and/or demand agent computing devices and non-registered supply and/or demand agent computing devices, among other examples.

145. In this embodiment FIG. 21 shows the application of augmented economic data system machine learning to create adaptive, emergent, evolutionary computer knowledge base datasets; encompassing contextual trade data, structures, dimensions, connections, perspectives, parameters and utility data, among other examples.

146. In this embodiment, as shown in FIG. 21, a plurality of unsupervised, supervised and reinforcement economic data system machine learning modules capture the contextual data trade dimensions, connections, perspectives as shown in FIGS. 21 2100, 2101, 2102, and 2103 2104 and use it to establish marketplace data factors as shown in FIG. 18 1803 that were and/or are active, their relative contextual data weighting, and to provide that input to the forward propagation of a plurality of evolutionary computational modular neural networks as shown in FIG. 4 422, FIG. 16 1603, FIG. 18 1804, and making that output selectively available as an abstraction with selective feedback to individual self-organizing supply and/or demand agent computing devices as shown in FIGS. 4 416 and 417 and FIG. 16 1612, among other examples.

147. In this embodiment, the output of the evolutionary computational modular neural networks FIG. 4 422, FIG. 18 1804, and FIG. 19 1903, FIG. 20 2009, and the supervised, unsupervised and reinforcement learning as shown in FIG. 21 is used to support further analysis and evaluate decision making data performance for individual and/or collective self-organizing supply and/or demand agent computing devices, among other examples.

148. In this embodiment, each self-organizing supply and/or demand agent computing device may make and apply their manually derived predictions independent of the economic data system feedback as shown in FIG. 16 1613, or utilize the recommendations of the evolutionary computational modular neural network(s) as shown in FIG. 16 1603 and FIG. 18 1804, to establish supply and/or demand agent computing device economic data system predictions, among other examples.

149. In this embodiment, at each cycle, the plurality of supply prediction data may be tested against the metrics of actual demand data as shown in FIG. 16 1611 and FIG. 20 2012 in that cycle, to establish the predictive accuracy of the past data cycle estimates as in FIGS. 16 1605, 1606, and 1607, and to process that data to create new predictions as in FIG. 16 1613 and FIG. 18 1805, among other examples.

150. In this embodiment, FIG. 16, FIG. 18 and FIG. 19 demonstrates a plurality of feedback loops, enhanced by augmented economic data system machine learning as in FIG. 16 1604 comparing both agent computing device and augmented economic data system machine learning derived predictions 1613 with actual demand data 1608, 1609, 1610 and the cumulative 1611 to create the contextual data shown as 1612 for transactions between and among a plurality of demand agent computing devices 1623, 1624, 1625 and at least one supply agent computing device 1602, among other examples.

151. In this embodiment, a plurality of structures, data and transactions are supported, with continuous feedback as shown in FIG. 4, utilizing the contextual data and data granularity (utility data) to calculate the cost function, perform self-organizing back propagation within the evolutionary computational modular neural network(s) to establish new self-organizing biases in the evolutionary computational modular neural network(s) that may be applied to improve stochastic demand-supply agent computing device prediction accuracy in each subsequent cycle, among other examples.

152. In this embodiment, as shown in FIG. 18 and FIG. 19 provides an example of the application of both the augmented economic data system machine learning and the evolutionary computational modular neural networks, to goods and/or services and/or assets inventory optimization, among other examples.

153. In this embodiment FIG. 4, FIG. 16, FIG. 18, FIG. 19, and FIG. 20 show the high level components making up transactional data, where each self-organizing supply and/or demand agent computing device has a set of self-selected and configured trade data relationships and shared catalog data that create, govern, constrain and contextualize what goods and services data may be shared and/or exchanged, among other examples.

154. In this embodiment, FIG. 20 shows an example of transactions and data, where there is a plurality of items data, sourced from a plurality of supply agent computing device data, to be fulfilled by a plurality of supply agent computing device/service providers, to a plurality of locations at different times with those transactions being alternately condensed and then expanded, among other examples.

155. In this embodiment as shown in overview in FIG. 20 and FIGS. 21 2100, 2101, 2102, 2103 and 2104 is an example of how contextual data in the form of a computer knowledge base dataset may be augmented continuously with transaction data as shown in FIG. 20 2001, 2002, 2003, 2004, 2005, 2006, 2007, 2008, stored as shown in 2009, 2010, 2012 and 2013, with said data being made available for utilization by economic data system machine learning 2011 within the economic data system, among other examples.

156. In this embodiment, identification, logging or data capture devices as shown in FIG. 6 606, may be initiated and used by supply and/or demand agent computing devices as shown in FIG. 6 605, and in FIG. 20 2004, for the purpose of creating, establishing and maintaining provenance, traceability, shipment tracking, anti-tampering, condition monitoring, and/or quality assurance data, with said data being appended to economic data blocks during transaction processing as shown in FIG. 20, including the actions of processing, consolidation and/or deconsolidation, and delivery as shown in FIGS. 20 2004, 2005, and 2006, with said data being made available within the economic data system to the related supply and demand agent devices as shown in overview in FIG. 16, and as inputs to machine learning as shown in FIGS. 16 1612 and 1604, among other examples.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of adaptive, and/or emergent and/or evolutionary computational modular neural network(s); comprising curated dynamic network architecture elements, alternating base paired data configuration protocols, processes, data exchange mechanisms and self-organizing supply and/or demand agent computing devices data inputs and/or outputs;
instantiated in at least one computational shared database which, when executed by at least one shared computing apparatus, causes said at least one shared computing apparatus to curate, and store combinations, sequences, and/or mutations and/or re-combinations of said dynamic network architecture elements; through selective applications of said alternating base paired data configuration protocols and processes; which, when subsequently, said alternating base paired data configuration protocols and processes are stochastically activated, configured and/or shared by said at least one self-organizing supply agent computing device and/or at least one demand agent computing device data inputs and outputs; and executed by said at least one shared computing apparatus, causes said at least one shared computing apparatus to create, contextualize, govern, constrain, and/or machine learn, store, analyze and/or predict, patterns and trends of adaptive, and/or emergent and/or evolutionary data, structures, dimensions, connections, relationships, perspectives, parameters and data exchange mechanisms, including location and utility, and/or multi-dimensional feedback loops, of an at least one goods and/or services and/or assets data, over time and space;
in an at least one adaptive, and/or emergent and/or evolving economic data block, and/or an at least one adaptive, and/or emergent and/or evolutionary self-organizing supply and/or demand private trading data network, and/or an at least one evolutionary economic data system over time and space.

2. The method of claim 1 whereby the dynamic network architecture comprising curated invariant, and/or interrelated, and/or interconnected, and/or interoperable, and/or interactive, and/or inter-networking elements, serve as individual and/or collective data module(s);

3. The method of claim 2 whereby the individual and/or collective data module(s) through the selective application of said alternating base paired data configuration protocols, process the self-organizing exchange mechanisms of the adaptive, and/or emergent and/or evolutionary data, structures, dimensions, connections, relationships, perspectives, parameters, exchange mechanisms, including location and utility, and/or multi-dimensional feedback loops, over time and space, of said goods and/or services and/or assets data;

4. The method of claim 1 whereby the alternating base paired data configuration protocols, and said dynamic network architecture elements process selections, combinations, sequences, and/or mutations and and/or re-combinations, caused by the stochastic selections, and/or configurations, and/or activations, and/or sharing of said at least one self-organizing supply agent computing device and/or at least one self-organizing demand agent computing device data inputs and/or outputs; within the created context, governance, constraints, learning, storage and analysis parameters of said at least one adaptive, and/or emergent and/or evolutionary′ computational modular neural network, and/or the dynamic network architecture elements and/or alternating base paired data configuration protocols, processes and exchange mechanism interactions, and/or multi-dimensional feedback loops, over time and space, instantiated in said at least one computational shared database, and curated, and stored by said at least one shared computing apparatus; and selectively shared between and/or among the at least one supply agent computing device and/or demands agent computing device, between and/or among an at least one evolutionary economic data system.

5. The method of claim 4 whereby individual and/or collective computational stochastic selections, configurations, processes, exchange mechanisms, storage and multi-dimensional feedback loops of at least one goods and/or service and/or asset's data, structures, dimensions, connections, relationships, perspectives, parameters, exchange mechanisms, including location, utility, over time and space; are stored, analyzed, processed and shared between and among said at least one self-organizing supply and/or demand agent computing devices to identify and/or validate, logical, adaptive, and/or emergent and/or evolutionary selections, configurations, connections, patterns and/or relationships, and/or individual and/or collective computing apparatus processes between and/or among said augmented economic data system machine learning structure, methods and processes of contextual data, structures, dimensions, connections, relationships, perspectives, parameters, exchange mechanisms, including location and utility, and multi-dimensional feedback data loops, over time and space;
storing the past, present, and predictive iterations of the augmented economic data system machine learning structure, methods and processing of contextual data, structures, dimensions, connections, relationships, perspectives, parameters, exchange mechanisms, including location, utility and multi-dimensional feedback loops, between and among said supply and/or demand computing devices, over time and space;
thereby creating, establishing and maintaining data provenance, traceability data, shipment tracking data, anti-tampering data, condition monitoring data, and/or quality assurance data;
within the evolutionary combination, sequence, mutation and re-combination, methods and processes constraining parameters of said augmented economic data system machine learning structure and methods.

6. A system of adaptive, and/or emergent and/or evolutionary computational modular neural network(s); comprising curated dynamic network architecture elements, alternating base paired data configuration protocols, processes, data exchange mechanisms and self-organizing supply and/or demand agent computing devices data inputs and/or outputs;
instantiated in at least one computational shared database which, when executed by at least one shared computing apparatus, causes said at least one shared computing apparatus to curate, and store combinations, sequences, and/or mutations and/or re-combinations of said dynamic network architecture elements; through selective applications of said alternating base paired data configuration protocols and processes; which, when subsequently, said alternating base paired data configuration protocols and processes are stochastically activated, configured and/or shared by said at least one self-organizing supply agent computing device and/or at least one demand agent computing device data inputs and outputs; and executed by said at least one shared computing apparatus, causes said at least one shared computing apparatus to create, contextualize, govern, constrain, and/or machine learn, store, analyze and/or predict, patterns and trends of adaptive, and/or emergent and/or evolutionary data, structures, dimensions, connections, relationships, perspectives, parameters and data exchange mechanisms, including location and utility, and/or multi-dimensional feedback loops, of an at least one goods and/or services and/or assets data, over time and space;
in an at least one adaptive, and/or emergent and/or evolving economic data block, and/or an at least one adaptive, and/or emergent and/or evolutionary self-organizing supply and/or demand private trading data network, and/or an at least one evolutionary economic data system over time and space.

7. The system of claim 6 whereby the dynamic network architecture comprising curated invariant, and/or interrelated, and/or interconnected, and/or interoperable, and/or interactive, and/or inter-networking elements, serve as individual and/or collective data module(s);

8. The system of claim 7 whereby the individual and/or collective data module(s) through the selective application of said alternating base paired data configuration protocols, process the self-organizing exchange mechanisms of the adaptive, and/or emergent and/or evolutionary data, structures, dimensions, connections, relationships, perspectives, parameters, exchange mechanisms, including location and utility, and/or multi-dimensional feedback loops, over time and space, of said goods and/or services and/or assets data;

9. The system of claim 6 whereby the alternating base paired data configuration protocols, and said dynamic network architecture elements process selections, combinations, sequences, and/or mutations and and/or re-combinations, caused by the stochastic selections, and/or configurations, and/or activations, and/or sharing of said at least one self-organizing supply agent computing device and/or at least one self-organizing demand agent computing device data inputs and/or outputs; within the created context, governance, constraints, learning, storage and analysis parameters of said at least one adaptive, and/or emergent and/or evolutionary′ computational modular neural network, and/or the dynamic network architecture elements and/or alternating base paired data configuration protocols, processes and exchange mechanism interactions, and/or multi-dimensional feedback loops, over time and space, instantiated in said at least one computational shared database, and curated, and stored by said at least one shared computing apparatus; and selectively shared between and/or among the at least one supply agent computing device and/or demands agent computing device, between and/or among an at least one evolutionary economic data system.

10. The system of claim 9 whereby individual and/or collective computational stochastic selections, configurations, processes, exchange mechanisms, storage and multi-dimensional feedback data loops of at least one goods data and/or service data and/or asset's dynamic contextual data, structures, dimensions, connections, relationships, perspectives, parameters, exchange mechanisms, including location, utility, over time and space; are stored, analyzed, processed and shared between and among said plurality of self-organizing supply and/or demand agent computing devices to continuously identify and/or validate, logical, adaptive, and/or emergent and/or evolutionary selections, configurations, connections, patterns and/or relationships, and/or individual and/or collective computing apparatus processes between and/or among said augmented economic data system machine learning structure, methods and processes of contextual data, structures, dimensions, connections, relationships, perspectives, parameters, exchange mechanisms, including location and utility, and multi-dimensional feedback data loops, over time and space;
storing the past, present, and predictive iterations of the dynamic augmented economic data system machine learning structure, methods and processing of contextual data, structures, dimensions, connections, relationships, perspectives, parameters, exchange mechanisms, including location, utility and multi-dimensional feedback data loops, between and among said supply and/or demand computing devices, over time and space;
thereby creating, establishing and maintaining data provenance, traceability data, shipment tracking data, anti-tampering data, condition monitoring data, and/or quality assurance data;
within the evolutionary combination, sequence, mutation and recombination, methods and processes constraining parameters of said adaptive, and/or emergent and/or evolutionary augmented economic data system machine learning structure and methods.
